(19) United States
(12) Patent Application Publication
(10) Pub. No.: US 2022/0366484 A1
(43) Pub. Date: Nov. 17, 2022

(54) DYNAMIC CONNECTION AND FACILITATED INFORMATION EXCHANGE BETWEEN ENTITIES

(71) Applicant: OUTPOST INTROS INC., Wilmington, DE (US)

(72) Inventor: Dane K. McDONALD, St. Louis, MO (US)

(21) Appl. No.: 17/628,508

(22) PCT Filed: Jul. 21, 2020
(86) PCT No.: PCT/US2020/042848

§ 371 Date: Jan. 19, 2022

Related U.S. Application Data
(60) Provisional application No. 62/877,062, filed on Jul. 22, 2019.
(60) Provisional application No. 63/012,531, filed on Apr. 20, 2020.

(51) Int. Cl. G06Q 30/08; G06Q 40/06

(52) U.S. Cl. CPC G06Q 30/08; G06Q 40/06

(57) ABSTRACT

The present disclosure relates to a system and method to match parties over a network. The parties may be different categories or types, such as companies seeking investment and investors seeking companies to invest in. The method may include receiving a plurality of first party characteristics associated with a first party, generating a first party abstract including at least some of the first party characteristics, receiving one or more second party characteristics associated with a second party, determining that one or more of the plurality of the first party characteristics match within a threshold of one or more second party characteristics, and transmitting a match notification to at least one of the first party or the second party.

### CROSS REFERENCE TO RELATED APPLICATIONS

This application is a national stage application under 35 U.S.C. § 371 of International Application No. PCT/US2020/042848, filed Jul. 21, 2020, entitled “Dynamic Connection of Companies and Investors,” which claims priority to U.S. Provisional Patent Application No. 62/877,062, filed Jul. 22, 2019, entitled “Dynamic Connection of Companies and Investors,” and to U.S. Provisional Patent Application No. 63/012,531, filed Apr. 20, 2020, entitled “Dynamic Connection and Facilitated Information Exchange Between Entities,” the contents of all of which are hereby incorporated herein in their entirety by reference for all purposes.

### FIELD

The present disclosure relates generally to matching services provided over a network.

### BACKGROUND

Startup companies require funding for capital expenditures, salaries, or the like, as they begin and continue to grow. For example, a startup will need funding for licenses, permits, equipment, real estate, insurance, legal fees, branding, market research, inventory, or the like. Often a startup company will turn to investors (e.g., a bank, venture capitalist, angel investor, investment firm, accelerator, incubator, etc.) for such funding. Investors are often selective in choosing a startup company to fund, making it difficult for a startup to find the right investor. For example, investors may desire a startup that targets a particular market, is in a specific financial cycle, has a certain amount of collateral, or the like. As more startups emerge, startups face increased difficulties finding an interested investor, and the number of investment options can become overwhelming for investors.

In current practice, a startup company may send multiple emails to numerous investors, the emails including sensitive and voluminous company information, in order to find one or two investors that are willing to meet. Such practices are time consuming for startup companies and are often times unsuccessful as many uninterested investors are contacted. Similarly, investors' inboxes become flooded with emails from startups, many of which are not a fit for the investor. With this massive influx of information, investors have difficulty keeping track of startup companies that reach out to them. Current organizational techniques involve multiple spreadsheets and long meetings with multiple investors trying to recall various startups and the progress and decisions of such startups. This can lead to missed connections and opportunities for both startup companies and the investors. In some cases, a startup may fail to get funding or an investor may bypass a startup company that emerges as a successful publicly traded company.

Various other entities seeking connections with other parties experience similar problems, where the entities must sort through copious amounts of data to find a party that is compatible. For example, funds seeking investors, hiring companies seeking job candidates, philanthropists seeking nonprofit organizations, entities looking to engage with private equity groups, freelance designers, writers, and creatives looking for clients, professional services looking for clients, or the like, may find it difficult to find a compatible counterpart when the amount of second parties is voluminous.

Similar to startups seeking funding from investors, funds may also seek funding from investors. Investors are often particular about the kind of funds they will invest in, such that searching for an investor likely to invest in the particular fund can be overwhelming, and vice versa. A hiring company may receive resumes from numerous candidates, many of which do not have proper qualifications for the job. The company must sort through all of the unqualified candidates to find qualified candidates, which can be time consuming and inefficient. A philanthropist seeking to support a non-profit or other charitable organization may find it difficult to find an organization to support amongst the numerous existing and emerging non-profits. A freelance creative or other independent contractor may want to reach out to larger companies to contract work, but not know where to look or how to market their skills and qualifications. An individual seeking a professional service firm, such as a law firm or private medical practice, may find it overwhelming to find the right professional that can meet the individual's needs (e.g., that has an affordable rate, a high success rate, sufficient resources, etc.). Alternatively, a professional service firm may have difficulty screening clients (e.g., to ensure they make timely payments, are requesting services the firm can execute, or the like).

The present disclosure is directed to systems and methods that improve coordination and communication between entities, such as the entities mentioned above.

### SUMMARY

In some embodiments, a method of matching companies and investors over a network is disclosed. The method includes receiving a plurality of company characteristics, wherein the company characteristics are associated with one or more companies and include financial information related to the respective company; generating a company abstract including at least some of the company characteristics; receiving one or more investor characteristics, wherein the one or more investor characteristics are associated with one or more investors; analyzing the one or more company characteristics and the one or more investor characteristics to determine one or more matches; determining one or more company characteristics match one or more investor characteristics based on the analysis; determining one or more companies associated with the one or more matching company characteristics match one or more investors associated with the one or more matching investor characteristics; and transmitting a match notification to the one or more matching companies and the one or more matching investors.

In some embodiments, communication on the platform, such as “direct messages” and the like may be prevented until a match notification is transmitted.

In some embodiments, a system to connect two types of parties is disclosed. The system includes a processing device and computer readable medium containing programming instructions that, when executed, will cause the processing device to receive a first type of characteristics corresponding to a first party; generate based in part on the first type of characteristics a first abstract summarizing at least some of the first type of characteristics; receive a second type of characteristics corresponding to a second party; transmit the first abstract to a second party device based on a match of at least one of the first type of characteristics and at least one of the second type of characteristics; and receive feedback from the second party regarding the first party.

In some embodiments, a method matching parties over a network is disclosed. The method include receiving a plurality of first party characteristics associated with a first party, generating a first party abstract including at least some of the first party characteristics, receiving one or more second party characteristics associated with a second party, determining that one or more of the plurality of the first party characteristics match within a threshold of one or more second party characteristics, and transmitting a match notification to at least one of the first party or the second party.

In another embodiment, a method for limiting interaction between parties over a network. The method includes receiving, from a first party user device, a request to conduct a communication transaction with a second party, determining by a processor, an account associated with the first party has sufficient credits for the communication transaction based on a cost associated with the communication transaction; enabling by the processor the communication transaction between the first party device and a second party device associated with the second party, and deducting by the processor the cost from the first party account.

In another embodiment, a method of promoting meaningful connections through a network is disclosed. The method includes receiving from a first party user device a request to transmit first party information to a second party, transmitting by a processor the request a second party user device, receiving from the second party user device an acceptance of the request, transmitting to the second party user device, the first party information, receiving from the second party user device a request to connect to the first party, generating by the processor, an introduction between the first party and the second party wherein the introduction provides contact information for the first party and the second party and transmitting by the processor the introduction to the first party user device and the second party user device.

In one embodiment, the introduction includes contact information that is outside of a network or system providing the request and acceptances of the first and second parties.

In an embodiment, a system to connect two types of parties is disclosed. The system may include a processing device and a non-tangible computer readable medium containing programming instructions that when executed will cause the processing device to: receive a plurality of first party characteristics corresponding to a first party, generating based in part on the plurality of first party characteristics a first abstract summarizing at least some of the first party characteristics, receive a plurality of second party characteristics corresponding to a second party, and transmit the first abstract to a second party device based on a match of at least one of the plurality of first party characteristics and at least one of the plurality of second party characteristics.

In another embodiment, a method for enabling quick connections between a first entity and a second entity is disclosed. The method includes receiving a selection of a connection link to a connection page, where the connection link is a uniform resource locator corresponding to the second entity, loading a resource corresponding to the connection link, receiving first entity characteristics corresponding to the first entity at the resource, validating the first entity characteristics based on the second entity characteristics, and enabling communication between the first entity and the second entity based on the validation.

This Summary is provided to introduce a selection of concepts in a simplified form that are further described below in the Specification. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 illustrates a system diagram of a system for party to party matching.

FIG. 2 illustrates a simplified block diagram of various computing devices of the system of FIG. 1.

FIG. 3 is a flowchart illustrating a method for matching one or more first parties with one or more second parties.

FIG. 4 is a flowchart illustrating a method of connecting a second party with a first party via a first party abstract.

FIG. 5 is a flowchart illustrating a method for verifying first party characteristics.

FIG. 6 is a flowchart illustrating a method of determining match recommendations based on entity behaviors.

FIG. 7 is a flowchart illustrating a method of notifying a second party of updates to first party characteristics.

FIG. 8A is a flowchart illustrating a method of matching first and second parties based on a search query.

FIG. 8B is a flowchart illustrating a method for allowing bypass connection options between entities.

FIG. 9 is an example of a graphical user interface for creating a company abstract.

FIG. 10 shows the graphical user interface of FIG. 9 with one or more categories/fields displayed for selection by a user.

FIG. 11 shows the graphical user interface of FIG. 9, showing simultaneous creation and display of the company abstract as a user enters company characteristics.

FIGS. 12A shows an exemplary graphical user interface on a company device for generating the company materials, displaying fields for creating a cover slide.

FIG. 12B shows a portion of the graphical user interface of FIG. 12A, displaying fields for creating an intro slide and problem slide.

FIG. 12C shows a portion of the graphical user interface of FIG. 12A, displaying fields for creating a solution slide, a market slide, and a deal terms slide.

FIG. 12D shows a portion of the graphical user interface of 12A, displaying fields for creating a wild card slide and finalizing the company materials.

FIG. 12E shows an exemplary graphical interface on the company user's device for previewing the created company materials.

FIG. 13 shows an exemplary graphical user interface on an investor's user device for displaying a company abstract in a pending requests queue.

FIG. 14 shows the exemplary graphical user interface of FIG. 13 with a company abstract selected in the queue.

FIG. 15A shows an exemplary graphical user interface on the investor's user device for displaying the company materials to an investor, with a cover slide displayed.

FIG. 15B shows the graphical user interface of FIG. 15A with an intro slide and a problem slide displayed.

FIG. 15C shows the graphical user interface of FIG. 15A with a solution slide and a market slide displayed.

FIG. 15D shows the graphical user interface of FIG. 15A with a deal terms slide and a wild card slide displayed.

FIG. 16 shows the graphical user interface of FIG. 13 after the investor has connected with the company, showing a company abstract moved to a connections category.

FIG. 17 shows the graphical user interface of FIG. 13 with a company abstract selected in an explore queue.

FIG. 18 is a flowchart illustrating a method of exchanging information between entities.

FIG. 19 shows an exemplary notification feed that can be displayed on a graphical user interface of an entity device.

FIG. 20 is a flowchart illustrating information sharing similar entity types.

FIG. 21 shows a portion of an exemplary graphical user interface including customizable link and search preferences.

FIG. 22 shows a portion of an exemplary graphical user interface for inputting entity characteristics.

FIG. 23 shows an exemplary trigger effects window on a graphical user interface of an entity device for customizing trigger effects.

FIG. 24 shows an exemplary introductions window for customizing introductions.

FIG. 25 shows an exemplary graphical user interface displaying a connected entities and updates queue.

FIG. 26 shows an exemplary graphical user interface for a company user device displaying investor information.

FIG. 27 shows a flowchart indicating a method for connecting investors.

FIG. 28 shows an exemplary dashboard displaying various metrics and analytics output.

FIG. 29 shows exemplary graphical user interfaces displaying charted metrics for engaged entities.

### DETAILED DESCRIPTION

The present disclosure relates generally to a system to reduce missed opportunities and connections and facilitate information exchange between different entities, such as businesses and capital entities, funds and investors, job applicants and companies, non-profit organizations and philanthropists, independent contractors and project managers, professional services and clients, mentors and mentees, and other ecosystems that rely on a many to one vetting and introduction process. In one embodiment, a system connects a first party (e.g., a company) and a second party (e.g., an investor) based on matching criteria or characteristics. The connection allows the transmission of information and communication between the two parties.

As one example, investors often require a company to meet certain criteria before investing in the company, where such criteria can be difficult for third parties to determine. For example, an investor may prefer to invest in companies in a certain market (e.g., software as a service, consumer products, oil and gas, entertainment, finance, etc.), round stage (e.g., Pre Seed, Seed, Series A, Series B, Growth, etc.), or the like. Often an investor must sift through a large volume of company information to find a company that meets the investor's preferences. This type of time intensive review also applies to other types of entities or parties, such as companies seeking job applicants, philanthropists searching for a non-profit organization (e.g., a 501c3) to support, venture or other funds looking to invest in other funds, entities desiring to engage with private equity groups, project managers or organizations looking to hire independent contractors or freelancers, clients seeking professional services, or the like. The matching system disclosed can organize, condense, and selectively exchange information between entities, such as companies and investors or the other entities mentioned above, to reduce the information exchanged between the entities, while also increasing probability of a connection, and minimizing missed opportunities.

The system optimizes the type and amount of information presented to an entity. Without limitation, as used herein, an “entity” or “party” may refer to a company (e.g., a startup or other organization), investor (e.g., a capital entity, venture capital firm, limited partner, angle investor, etc.), fund (e.g., a venture capital fund), job applicant or candidate, non-profit organization (e.g., a 501c3), independent contractor (e.g., a freelance designer, writer, or other artist or vendor), professional service (e.g., law firm, private medical practice, therapist, etc.), mentee, mentor, hiring entity (e.g., recruiter, hiring company, human resources department, hiring manager, etc.), philanthropist, project manager, client, or other associated person, representative, or the like. The entity or party may have one or more users accessing the system through one or more entity or party devices. For example, the one or more users may be founders, partners, executives, employees, contractors, or the like, associated with the entity or party.

The matching system may receive entity characteristics (either retrieved and/or entered directly by a user) and organizes relevant characteristics or summarizes the entity characteristics into an abstract. Entity characteristics may include identifying information (e.g., name, type of organization, location, credentials, etc.), financial information, background information, behavioral trends (e.g., how the entity interacts with the system and other parties on the platform, historical behaviors and actions, etc.), ranking, or the like. The entity abstract may be a summary, bundle or package of relevant information about the party or entity, such as a graphical icon displaying select entity characteristics (e.g., a “billboard” or slide), where the entity abstracts include the same information for a category of entities, e.g., all startup companies, allowing a user to quickly and easily compare information across multiple entities. In several embodiments, the entity abstract is transmitted to select parties to share information. The entity abstract is used as a connection tool and enables communication between entities on the platform, but in a uniform and managed manner. As one example, a company may send a company abstract to an investor, and, after reviewing the high level information in the abstract, the investor may indicate a follow-up for the startup, such as by selecting the company abstract, reviewing the information, and connecting with the company if interested.

The system analyzes entity abstracts and other entity characteristics to automatically determine matches between parties. For example, the system may analyze one or more first party abstracts (e.g., company abstracts) and one or more second party abstracts (e.g., investor abstracts) to determine whether there are one or more matches between a first and second party (e.g., between a company and investor). In one example, the system may transmit a first party abstract (e.g., company abstract) to a second party (e.g., investor) when one or more first party characteristics match one or more of the second party's characteristics. In this manner, the system filters out first party information that does not match the preferences of the second party, reducing the number of first parties presenting information to the second party (e.g., in the case of companies presenting information to investors) or filtering first parties unlikely to be interested in the second party, increasing probability the second party will find an interested first party (e.g., in the case of a startup company searching for an interested investor). Additionally, in some instances, parties may not communicate directly on the platform, but rather the match notification or actions after such a match may provide contact information (e.g., email, phone number, social media user name, etc.). Alternatively or additionally, parties may be prevented from directly communicating on the system until a match notification is generated, to help prevent entities from receiving numerous, irrelevant, communications.

In some instances, an entity can select a party abstract of interest to review more details about the party. For example, an investor can select a company abstract to review additional company materials, such as a slide deck, presentation, or other information. As another example, a hiring company can select a candidate abstract to review additional details about the candidate, such as resumes, transcripts, writing samples, or the like. The matching system may place limits on the data an entity can input into the system, e.g., the system may restrict the number of slide decks input by a company or length of writing samples uploaded by a job candidate, thereby providing more meaningful information exchange.

The matching system can also provide recommendations for connections between parties. For example, the system may monitor entity behavior, assess behavioral trends, preferences, changes over time, and/or qualify (e.g., rank) different parties. For example, a ranking may be a connection probability for a party, e.g., a high ranking may indicate a high probability of connection, while a low ranking may indicate a low probability of connection. As another example, a ranking may indicate a party's level of activity (e.g., with the system, with other parties, etc.), with a high ranking indicating a high level of activity and a low ranking indicating a low level of activity. For example, the system may determine the number of company abstracts an investor reviews before making a connection with a startup and rank the investor based on the investor's connection rate. As another example, the system may determine changes in a company's characteristics over time and rank the company based on the company's data trend. As another example, the system may determine a company is selected by multiple investors and rank the company as a desirable (e.g., red hot) company. The system may selectively exchange entity information based on determined rankings.

The matching system may also help reduce irrelevant, duplicative, or otherwise superfluous information exchanged between parties by a credit system. For example, a party may be allotted a particular number of tokens, credits, or the like, e.g., 1 to 10 credits. Credits may be used (or spent) to “purchase” connections with another party (e.g., to request an introduction). For example, a first party may use a credit to send first party information (e.g., in a first party abstract) to a particular second party. As another example, a second party may use a credit to initiate contact with a first party. Credits may be reset after a particular time period, e.g., credits can be allotted and reset by week, month, or bi-monthly, or as the entities transition to new benchmarks, e.g., reset between Series A and Series B funding rounds, or based on a payment plan, e.g., reset for each billing cycle. With the limitations on communications imposed by the credit or tokens, parties will be more strategic with contact or introduction requests, reducing volume across the platform and resulting in more meaningful engagement between parties.

The matching system may also include timing restrictions, to help motivate parties to engage. For example, when a first party abstract is transmitted to a second party, the first party abstract may be displayed to the second party in a queue of other abstracts to be reviewed by the second party. The second party may then have a set number of days or other time frame to review the first party abstract and either decline or seek further information.

In one example, the system may include a connection link that may be provided, for example, via a uniform resource locator (URL) link, e.g., https://sendinfo.com/investorname. An entity may then select the link, which will directly and quickly connect the two entities. For example, a startup can select the connect link of an investor and upon selection, the system will transfer the startup's data to the investor and connect the entities within the system. In some instances, the system may also act to filter the connections via the connection link so that only entities that are “matched” are connected. For example, if a startup is raising a Series C funding round and selects an investor's connect link where the investor only invests in Series A, the system may not transmit information or may not display the startup's information to the user. In some implementations, the connect link may be restricted, such as by use of tokens or credits, such that the quick connection option that may bypass certain approvals may be used in a limited manner.

By homogenizing and controlling information exchange between two or more entities or parties on the system (e.g., companies and investors, job applicants and hiring parties, non-profits and philanthropists, employers and independent contractors, professionals and clients, various equity groups or funds, etc.), while also assisting different types of parties in finding compatible counterparts, and encouraging quick decisions on such compatibility, the system can increase matches and successful business transactions, with less data and communication between the parties.

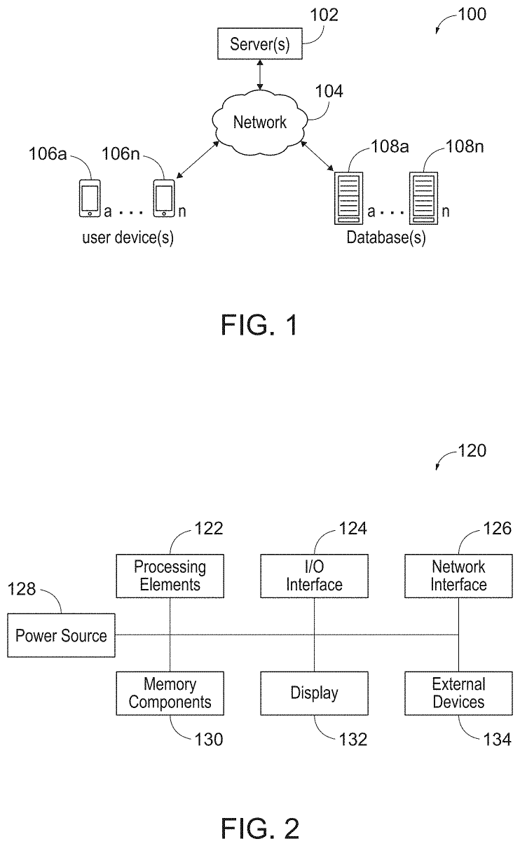

Turning now to the figures, a system of the present disclosure will be discussed in more detail. FIG. 1 is a block diagram illustrating an example of a party-to-party matching system 100, e.g., a company-to-investor, hiree-hirer, non-profit-philanthropist, independent contractor-employer, professional-client, fund-fund, etc. matching and communication platform. The system 100 includes one or more user devices 106a-n and one or more databases 108a-n. The system 100 may also include one or more servers 102, which may be in communication with the user device(s) 106a-n and database(s) 108a-n. The various components of the party-to-party matching system 100 may be in communication directly or indirectly with one another, such as through a network 104. In this manner, the components can transmit and receive data from other components in the system. For example, the server 102 may be in communication with the user device(s) 106a-n and database(s) 108a-n over the network 104. In many instances, the server 102 may act as a go between for some of the components in the system 100.

The network 104 may be substantially any type or combination of types of communication system for transmitting data either through wired or wireless mechanism (e.g., cloud, Wi-Fi, Ethernet, Bluetooth, cellular data, or the like). In some embodiments, certain components in the party-to-party matching system 100 may communicate via a first mode (e.g., Bluetooth) and others may communicate via a second mode (e.g., Wi-Fi). Additionally, certain components may have multiple transmission mechanisms and be configured to communicate data in two or more manners. The configuration of the network 104 and communication mechanisms for each of the components may be varied as desired.

The server 102 includes one or more computing devices that process and execute information. The server 102 may include its own processing elements, memory components, or the like, and/or may be in communication with one or more external components (e.g., separate memory storage) (an example of computing elements that may be included in the server 102 is disclosed below with respect to FIG. 2). The server 102 may also include one or more server computers that are interconnected together via the network 104 or separate communication protocol. The server 102 may host and execute a number of the processes executed by the system 100.

The server 102 has or offers a number of configurable application programming interfaces (API) that can be accessed and used from an application on a user device 106 to send and receive data to the server 102. To prevent unauthorized access, all applications may be required to authenticate sessions or connections via a license key or other code. An advantage of this architecture is that each user obtains a streamlined, uncluttered view of relevant activity to the user.

The user device(s) 106a-n may be any of various types of computing devices, e.g., smart phones, tablet computers, desktop computers, laptop computers, set top boxes, gaming devices, wearable devices, or the like. The user device(s) 106a-n provides output to and receives input from a user. For example, the user device(s) 106a-n may receive entity information updates (e.g., company data or investor preference updates) from a user and output entity data and notifications or alerts to a user. The type and number of user devices 106a-n may vary as desired.

The database(s) 108a-n may be an internal or external database. For example, the database 108 may be an internal database storing entity data (e.g., as entity abstracts) and entity preferences (e.g., an investor abstract) input into the system 100. As another example, an external database may be accessed, for example, that contains public information on an entity (e.g., business and/or financial information). In many instances, the system may include a combination of internal database and external databases, where the external database(s) can supplement data for the internal database(s).

A simplified block structure for a computing device that may be used with the system 100 or integrated into one or more of the system 100 components is shown in FIG. 2. For example, the server 102, user device(s) 106a-n, and/or database(s) 108a-n may include one or more of the components shown in FIG. 2 and use one or more of these components to execute one or more of the operations disclosed in methods 150, 200, 250, 300, 320, 350, and 800. With reference to FIG. 2, the computing device 120 may include one or more processing elements 122, an input/output interface 124, a network interface 126, a power source 128, one or more memory components 130, a display 132, and one or more external devices 134. Each of the various components may be in communication with one another through one or more busses, wireless means, or the like.

The one or more processing elements 122 are any type of electronic device capable of processing, receiving, and/or transmitting instructions and data. For example, the processing element 122 may be a central processing unit, microprocessor, processor, microcontroller, graphical processing unit, or a combination of multiple processing elements. For example, a first processing element may control a first set of components of the computing device and the second processing element may control a second set of computing devices, where the first and second processing elements may or may not be in communication with one another. Additionally the processing elements may be configured to execute one or more instructions in parallel.

The input/output (I/O) interface 124 receives and transmits data to and from the network 104. The input/output interface 124 allows a user to enter data into the computer 120, as well as provides an input/output for the computer 120 to communicate with other devices (e.g., server 102, other computers, speakers, etc.). The I/O interface 124 can include one or more input buttons, touch pads, and so on. The input/output interface 124 may be configured to send and receive HTTP requests.

The network interface 126 provides communication to and from the computer 120 to other devices. For example, the network interface 126 allows the server 102 to communicate with the user device(s) 106a-n through the network 104. The network interface 126 includes one or more communication protocols, such as, but not limited to Wi-Fi, Ethernet, Bluetooth, and so on. The network interface 126 may also include one or more hardwired components, such as a Universal Serial Bus (USB) cable, or the like. The configuration of the network interface 126 depends on the types of communication desired and may be modified to communicate via Wi-Fi, Bluetooth, and so on.

The power 128 provides power to various components of the computing device 120. The power 128 may include one or more rechargeable, disposable, or hardwire sources, e.g., batteries, power cords, or the like.

The one or more memory components 130 stores electronic data, such as, for example, entity data (e.g., company data, investor data, etc.), credit data, timing information, or the like, that may be utilized by the computing device 120. The one or more memory components 130 may include electrical data or content, such as processor instructions (software code), audio files, video files, document files, or the like. The one or more memory components 130 may include multiple components, such as, but not limited to, non-volatile storage, a magnetic storage medium, optical storage medium, magneto-optical storage medium, read only memory, random access memory, erasable programmable memory, flash memory, or a combination of one or more types of memory components. In many embodiments, the server 102 may have a larger memory capacity than the user devices 106a-n.

The display 132 provides visual feedback to a user and, optionally, can act as an input element to enable a user to control, manipulate, and calibrate various components of the computing device 120. The display 132 may be a liquid crystal display, plasma display, organic light-emitting diode display, and/or cathode ray tube display. In embodiments where the display 132 is used as an input, the display 132 may include one or more touch or input sensors, such as capacitive touch sensors, resistive grid, or the like.

The external devices 134 are one or more devices that can be used to provide various inputs to the computing device 120, e.g., mouse, microphone, keyboard, trackpad, or the like. The external devices 134 may be local or remote and may vary as desired.

### Entity Matching

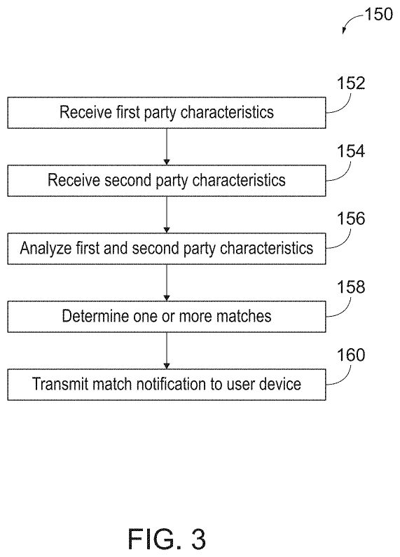

FIG. 3 is a flow chart illustrating a method for matching one or more first party or entity types with one or more second party or entity types. The matching algorithm used by the system may be based on the relationship and attributes of the entities to determine entities most likely to engage with one another. The method 150 begins with operation 152 and entity characteristics of a first party (i.e., first party characteristics) (e.g., a company) are received by a processor. Entity characteristics may be input into the system, received from a database, and/or determined by the system. As one example, entity characteristics may be input by an entity user or representative (e.g., a founder, executive, employee, applicant, or the like) via an entity user device. For example, an entity user may create an entity user account with an application or web browser on the entity user device. To create the entity user account, the entity user may input identifying information, such as, for example, the entity user's name, email address, and phone number, and, if applicable, the entity name, address, employer identification number (EIN), year founded, type of organization, type of formation (e.g., S-Corp, C-Corp, LLC, LLP, etc.), or the like. In some examples, the entity user may input the entity user's gender to receive proper introductions to other parties. In some embodiments, the entity user's identity may be verified. For example, the entity user may receive a text message or email with a verification code. Upon providing the code, the entity user can access the system and create an entity account.

In some embodiments, after logging into the entity account, an entity user can input one or more entity characteristics. Entity characteristics may include information relevant to the entity's business, practices, strategies (e.g., investment strategy for a startup), solutions, financial status, qualifications, skills, or the like, and as should be understood, vary depending on the types of entities utilizing the system. For example, entity characteristics for a company may include financial status or progress (e.g., stage, revenue, lead investor or not, etc.), funding rounds (e.g., round size, size of investments, etc.), company missions or goals, technology, market, location, size, stage, etc.; for a job applicant or independent contractor, characteristics may include education, job history, job preferences, special skills, location, etc.; for a fund, characteristics may include average fund size, investment preferences, number of investors, years in operation, etc.; for a non-profit organization, characteristics may include mission statement, 501c3 status, target market, etc.; for a professional service, characteristics may include type of service, professional bios, degrees, client satisfaction ratings, fees, etc.

The entity characteristics may be extracted and summarized to generate an entity abstract or billboard, in this instance, a first party abstract or billboard. An entity abstract may be a graphical display, bundle, or package of a set of information related to the entity, allowing a category of entities to present data in a uniform manner across the system. For example, the entity abstract (e.g., a company abstract) may include information related to the entity characteristics, including parameters that may be of interest to a second category of users or parties (e.g., investors), and may be varied based on the types of users as well over time.

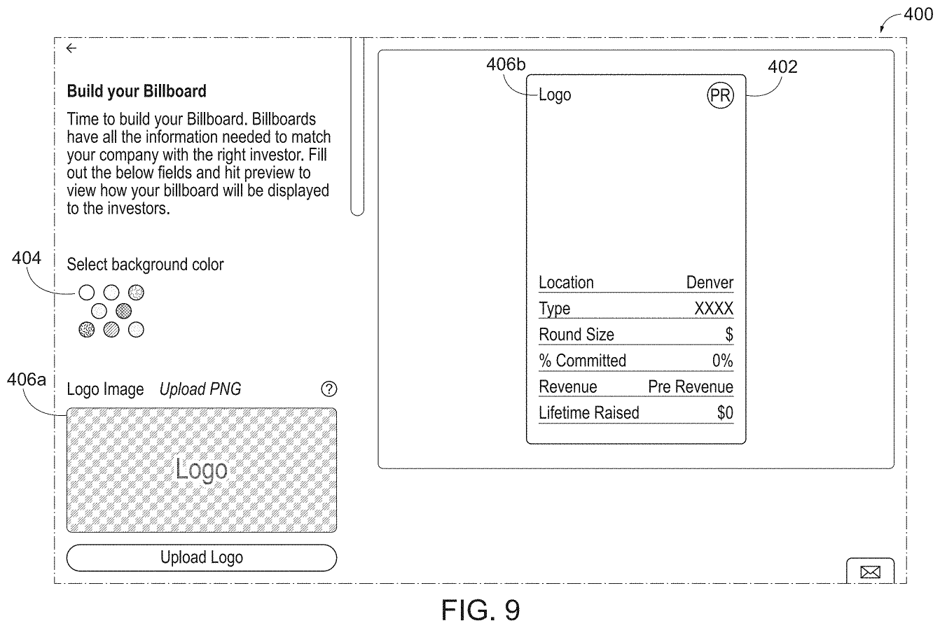

FIGS. 9-11 show an exemplary window displayed on a graphical user interface for simultaneous generation of an entity abstract (e.g., a company abstract) as a user inputs party (e.g., company) characteristics into the system. As shown in FIG. 9, a graphical user interface displays a window 400 including segments and icons for inputting company characteristics to create a company abstract 402. In addition to characteristics, the system may include options for design characteristics for the abstract, such as for example, shape, size, pattern, color, border, graphic, or the like, to distinguish an entity's abstract from that of other entities. For example, the background color 404 of the company abstract 402 can be adjusted. The design characteristics may be limited to a menu of options, rather than allowing the user to have full control, further enhancing uniformity across the platform.

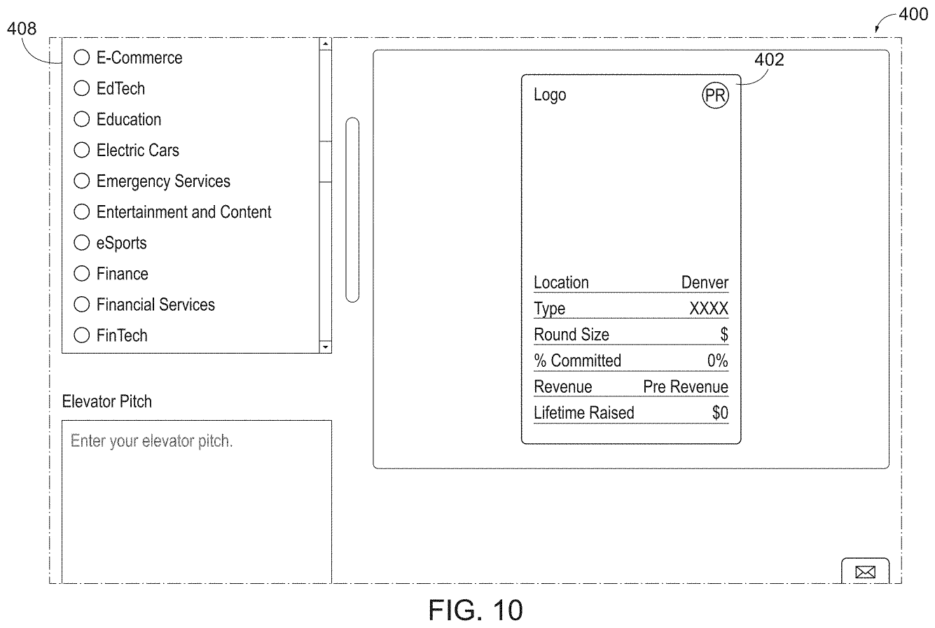

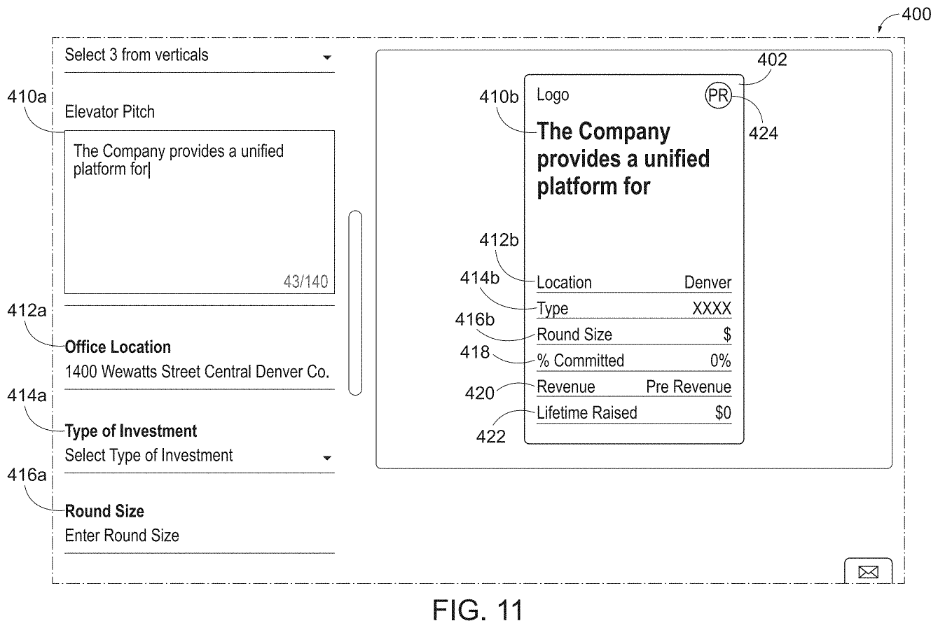

As shown in FIG. 9, the system may receive input of a logo image 406 or other representative image of an entity (e.g., a profile picture), e.g., by company user uploading the image via the company user device. The system may automatically populate the logo image 406a as a logo 406b on the company abstract 402. The system may be configured to automatically adjust the color of the logo (e.g., to black or white) depending on the background color 404 selected for the abstract, for example to ensure the logo stands out. As shown in FIG. 10, a company user may associate the company abstract 402 with one or more categories/fields by selecting one or more categories/fields 408 that encompass the company's business practices. In some examples, the system may display a limited number of categories that they user can select as an input. As one example, a user may only select three categories to describe the company's business. As shown, a user may select from a drop down menu of categories, such, as for example, education, emergency services, eSports, finance, or the like. The one or more categories/fields 408 selected may be saved as metadata associated with the company abstract 402 or may be displayed within the company abstract 402. As shown in FIG. 11, a company user may enter a brief description of the company, such as an elevator pitch or quick summary 410a. The number of characters for the brief company description may be limited by the system, for example to a maximum of 140 characters. As shown, the elevator pitch 410b populates within the company abstract 402 as the company user enters the information; however, it is contemplated that the elevator pitch 410b is displayed within the company abstract 402 after the company user submits the information.

Other company characteristics may be input into the system, such as for example, company location 412a,b, type of investment 414a,b (e.g., priced, convertible note, SAFE, debt, etc.), round size 416a,b, amount or percent committed 418, revenue 420, lifetime raised 422 (e.g., funding raised to date), round stage (e.g., Pre Seed, Seed, Series A, Series B, Growth, etc.), or the like. In some examples, the system automatically categorizes the values input by an entity user into buckets, such as, for example, above a certain number, below a selected number, or within a set value range. For example, a company user may input a value of $11.6 million in revenue, and the system may automatically categorize the value as $10m+, or $10 m-$15 m, or <$20 m, or the like. Any range, minimum, or maximum value is contemplated (e.g., $1 m-$1.5 m, $1 m-$5 m, $ 5 m-$10 m, $ 500 K-$1 m, $ 2 m-$3 m, <$100 K, etc.). An entity user may also indicate yes or no for certain circumstances. For example, a company user may indicate whether the company is post revenue and, if yes, input the company's trailing 12 months revenue, whether the company has used an accelerator and, if yes, input the accelerator name, and whether the company has a lead investor and, if yes, input the investor name.

One or more of the company characteristics input into the system are displayed within the company abstract 402, and the characteristics can be displayed in varying manners, e.g., as a numerical value, text, a badge 424, or the like. For example, a badge may be a graphic or symbol indicating a characteristic of an entity. For example, a badge may indicate a company round stage, that a company went through an accelerator, that a company has a lead investor, a company revenue value, verification of the company, or the like.

One or more entity characteristics input into the system may be metadata associated with an entity abstract and may not be viewable by the entity abstract. Instead, the one or more characteristics may be included as metadata that can be used by the system to determine matches, track trends over time, or the like.

As another example, one or more entity characteristics may be received from a database. For example, a database may include public information on a company, such as the financial status, funding, round stage, market trends, or the like. The system may periodically pull information from a database to update entity characteristics or may pull the information upon request (e.g., by request of an investor). As shown in FIGS. 9-11, the one or more company characteristics may automatically be organized within the company abstract 402 or saved as metadata associated with the company abstract 402.

As yet another example, one or more entity characteristics may be determined by the system. For example, the system may monitor one or more behaviors associated with an entity user and/or an entity's abstract, and analyze the one or more behaviors to determine behavioral trends. In some embodiments, behaviors monitored may include number of requests for an entity abstract, speed that an entity abstract is reviewed, types of entities requesting an entity abstract (e.g., types of funds requesting a company abstract), amount of time an entity abstract has been in the system, or certain entity-specific behaviors (e.g., for a company, round size changes, rating of lead investor, etc.), or the like.

The system may analyze the entity behaviors to determine particular trends, for example, an entity's popularity relative to other like entities (e.g., entity trend), an entity's likelihood to respond, an entity's likelihood to engage (e.g., based on the entity's prior engagements, historical activity, market-wide activity, and existing characteristics that may impact engagement behavior), market or vertical trend, location trend, demand for the entity, entity virality, or the like. As one example, an investor's likelihood to invest may be determined by the system based on one or more of prior investments, amount remaining in the investor's fund, historical activity, and market-wide activity. The behavioral trends may be translated into qualifications or rankings. In some embodiments, the behavioral trends and/or qualifications or rankings are stored as one or more entity characteristics associated with the entity abstract.

With reference again to FIG. 3, after operation 152, the method proceeds to operation 154 and second party characteristics (e.g., investor characteristics) are received by the processor. Similar to the input of first party characteristics discussed above with respect to operation 152, the second party characteristics may be input by an entity user, received from a database, or determined by the system. As one example, a second party may input information about the second party, such as, type (e.g., a bank, venture capitalist, angel investor, investment firm, accelerator, philanthropist, type of hiring company, type of professional service, etc.), financials (e.g., fund size, salaries, rates, etc.), location, historical data (e.g., historical number of investments or hires, historical fund size or salaries or rates, historical types of companies invested in or hirees, etc.), or the like. The second party characteristics may be counterparts to the first party characteristics. For example, a second party may input preferences for one or more first party characteristics. For example, an investor may have a preference for a company's market, age, amount committed, funding round, location, lifetime raised, prior funding experience, size, stage, preferred investment amount, round size, revenue, lead investor or not, or the like. As another example, a hiring company may have a preference for a hiree's education, job experience, skills, qualifications, or the like. As yet another example, a project manager may have a preference for a particular type of freelance artist or vendor, with a particular amount of experience, and other qualifications.

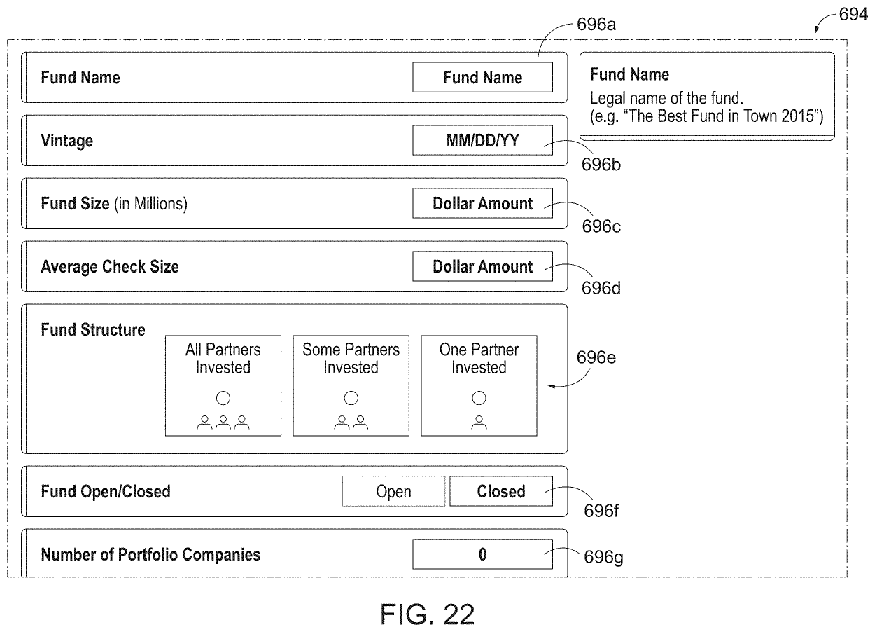

FIG. 22 shows an example of entity characteristics that may be input by an investor. For example, an investor may add fund information directly into the system. In the depicted example, the system displays a window 694 customized to receive specific fund information on a graphical user interface of the investor device. As shown, the window 694 includes input buttons 696a-g to input the fund information including, fund name, vintage (e.g., when the fund started, MM/DD/YY), fund size (e.g., dollar amount, e.g., in millions), average check size (e.g., of investment for the fund, dollar amount), fund structure (e.g., of the users on the account, e.g., who is involved in the fund and should receive deal flow for the fund), fund open/closed (e.g., active and investing or closed and money has been allocated), and number of engaged companies, respectively. Other input means are contemplated for inputting entity characteristics, for example text boxes, drop down menus, or the like.

As another example, second party information may be received from a database including public information about the second party (e.g., market trends, historical activity, financial status, etc.), a social media platform (e.g., LinkedIn, Facebook, or other platform including information about an individual or organization), a public records database (e.g., Internal Revenue Service website, Secretary of State website, etc.), or the like.

As yet another example, the one or more second party characteristics may be determined by the system, for example, as discussed above with respect to the first party characteristics. The system may monitor one or more second party behaviors and analyze the one or more behaviors to determine behavioral trends. For example, behaviors monitored may include search history on first party abstracts, probability of contacting a first party after reviewing a first party's abstract, number of expired requests to review a first party abstract, first party characteristics of first party abstracts reviewed and/or first parties contacted, or the like. The system may analyze the second party behaviors to determine behavioral trends, e.g., as discussed above with respect to the first party characteristics, e.g., entity trend, likelihood to respond/engage, location-based trends, entity demand/virality, vertical/market trend, or the like. The behaviors may be translated into qualifications and or rankings. In some embodiments, the behavioral trends and/or qualifications or rankings are stored as one or more second party characteristics.

In some examples, the system may automatically categorize the values for the second party characteristics into buckets, such as, for example, above a certain number, below a selected number, or within a set value range. In some examples, the system may organize one or more of the second party characteristics into a second party abstract similar to the first party abstract discussed above. For example, the second party abstract may be a graphical representation of second party characteristics. For example, a second party characteristic may be displayed as a numerical value, text, badge, or the like, within the second party abstract. In some examples, one or more second party characteristics may be saved as metadata associated with the second party abstract.

After operation 154, the method 150 proceeds to operation 156 and the first and second party characteristics are analyzed. For example, the system may analyze entity (e.g., company and investor) characteristics to determine whether one or more characteristics match or are compatible. For example, the system may determine location characteristics are compatible when the characteristics indicate the first and second party are in the same general location. As another example, the system may determine characteristics match when a first party meets the second party's criteria. For example, the system may determine characteristics match when an investor characteristic indicates preference for a company in a certain field and a company characteristic indicates the company is in the field.

In embodiments where the entity characteristics are provided as selectable fields, the system may be readily able to identify matches between fields of different entities. In other examples, such as user entered information, the system may use language analysis techniques, such as a natural language processor, or the like, to determine matches between characteristics. As another example, the system may store key words corresponding with matching characteristics and use the information stored to determine a match.

In some embodiments, the system may factor in the behavioral characteristics of the entities when analyzing the first and second party characteristics to determine a match. For example, the system may analyze whether entities have similar response rates, engagement rates, trends, demand, or the like. For example, entities may be considered to have similar behavioral characteristics or trends, when their trends match by a particular percent (e.g., greater than 80%, 90%, 95%, etc.) or deviate by a particular percent (e.g., less than 1%, less than 5%, less than 10%, less than 15%, less than 20%, or the like). As one example, a response rate of 95% may be considered to match a response rate of 97%. By including behavioral characteristics in the analysis, the system may be able to determine entities more likely to engage.

As part of the analysis, the system may determine the number of matching or compatible characteristics shared between entities. In some embodiments, the system may translate this number into a percent match. For example, if a company and an investor have 10 out of 20 characteristics matching or compatible, the system may determine the company and the investor are a 50% match or have 50% compatibility.

After operation 156, the method 150 proceeds to operation 158 and the system determines whether one or more matches exist between one or more first parties and one or more second parties based on the analysis. In some embodiments, a match between entities may be determined when entities match above a certain threshold. For example, entities matching above 40%, 50%, 60%, 70%, 80%, or 90%, or the like, may be considered a match. As an example, a company and an investor match when the amount of company characteristics and investor characteristics matching exceeds the threshold amount. In some embodiments, a match between entities may be determined when one or more key characteristics match. As one example, a key characteristic may be a characteristic a party or the system marks as important or controlling. For example, an investor may mark as important a company's market, funding round, and fund size. In this example, a match is determined when at least a company's market, funding round, and fund size match the investor's preferences.

In other embodiments, one or more characteristics are weighted, such that a match is determined when one or more characteristics having greater weight match. In other words, if one or more characteristics that are given little to no weight do not match, a match between entities can still be determined if the one or more characteristics given weight match. As yet another example, the system may use predictive analytics to determine a likely match. For example, based on investor trends, a system may determine one or more company characteristics are desirable and match companies having the desirable characteristics with the investor.

After operation 158, the method 150 proceeds to operation 160 and the match notification is transmitted to one or more user devices. For example, when the system determines a first and second party match, the system may transmit a match notification to one or both of the first and second party user devices. The match notification may be in the form of an email, an alert, or an entity abstract. As one example, the system may transmit either or both of the first and second party abstracts (or other information) to the respective second and first party user devices. The entity abstract may be displayed on a user interface of the respective user device. For example, the abstract may be displayed in a particular section of the interface, such as an “Explore” section or “Recommendation” section. A first or second party may review the Explore or Recommendation section to review matching second party abstracts or first party abstracts, respectively.

### Connecting Entities Across the Platform

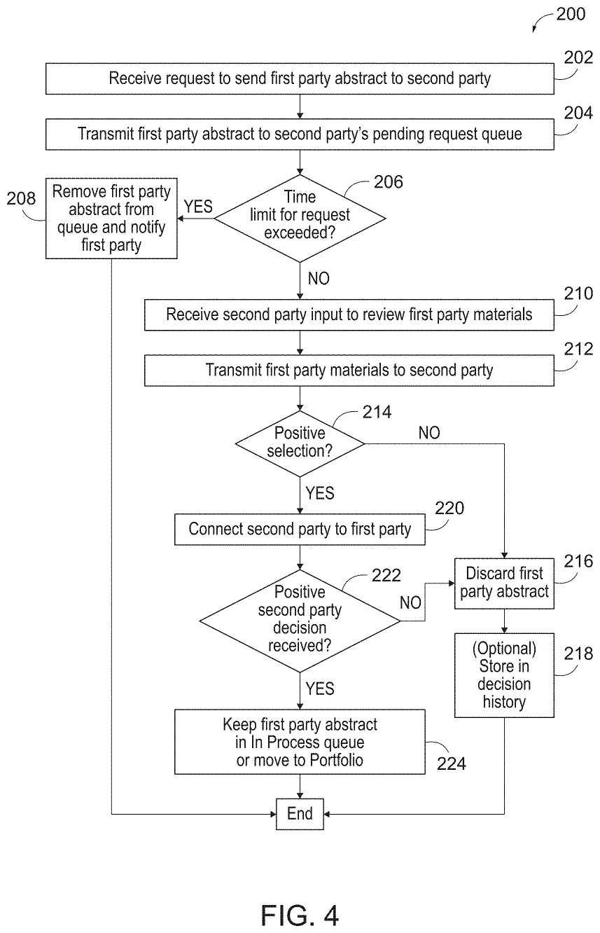

FIG. 4 is a flow chart illustrating a method of connecting entities (e.g., an investor with a company) via an entity abstract (e.g., company abstract). The method 200 begins with operation 202 and a request to send a first party abstract (e.g., a company abstract) to a second party (e.g., an investor) is received. For example, as discussed above, the system may display one or more matching second party abstracts to a first party user on a user interface of the first party device. In some embodiments, the first party user may select a second party abstract to review additional details related to the second party. When a first party user determines a second party is compatible, the first party user may submit a request to send the second party the first party's abstract. For example, investor abstracts may be displayed to a company user on a company device, and the company user may select an investor abstract to review additional details. When the company user determines an investor falls into a category of those likely to invest in the company, the company user may submit a request to send the investor the company's abstract to allow the investor to review the company's details and determine whether to invest in the company.

In some embodiments, a first entity may only be able to transmit a request in operation 202 if the first entity has been matched with the second entity as described in the method 300. In this manner, the number of requests being analyzed and transmitted across the platform may be limited, and users may be not inundated with requests for non-compatible entities.

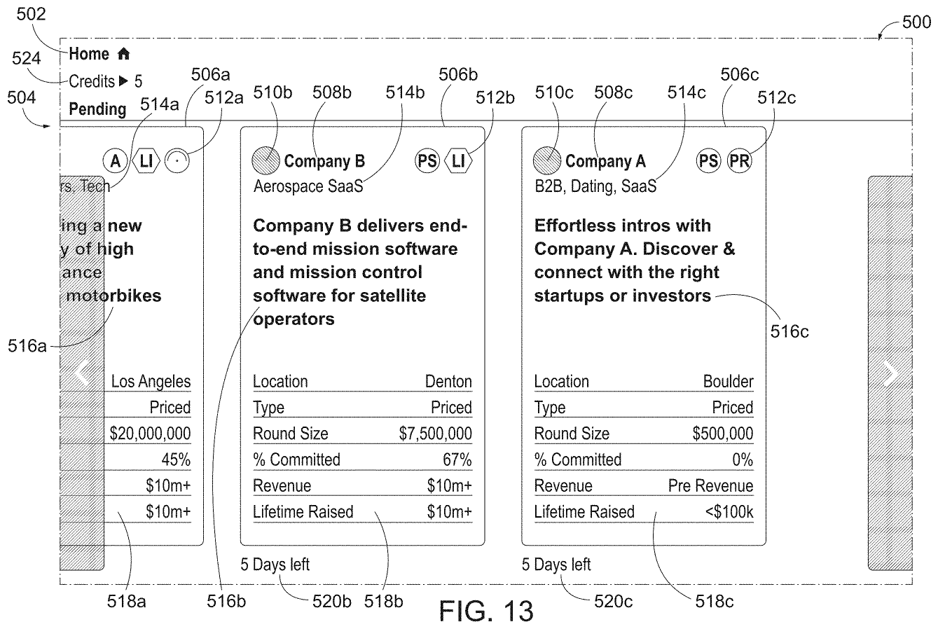

After operation 202, the method 200 proceeds to operation 204 and the first party abstract (or other data or information) is transmitted to the second party's pending requests queue. The pending requests queue may be a list of pending abstract review requests from other parties (e.g., companies). FIG. 13 shows an exemplary graphical user interface on an investor user device for displaying a company abstract in a queue. As shown, the user interface displays a window 500 having a home screen 502 displaying an entity pending requests queue 504 of pending review requests from various companies. For example, if a company sent the investor the company's abstract, the company abstract may appear in the pending requests queue 504. The entity pending requests queue 504 includes a plurality of company abstracts 506a-c. As discussed, each company abstract 506a-c includes a company name 508a-c and logo 510a-c, one or more badges 512a-c, categories 514a-c, an elevator pitch 516a-c, and other company characteristics 518a-c arranged for easy and quick review. The pending requests queue 504 may be scrollable, and, as shown, can be toggled to the left or right to view more company abstracts. While the pending requests queue 504 is displayed horizontally with left to right toggle function, it is also contemplated that the queue may be displayed vertically with up and down toggle function.

In some instances, the system may receive input by an entity to send an alert or emphasize the entity's abstract or otherwise adjust the status while the request is pending in the queue, e.g., “boost” the information visibility to another party and draw the party's attention to the entity's action and/or entity abstract. For example, a company may request the system send a boost to an investor that previously received the company's abstract. A boost may change the position of the company abstract within the queue (e.g., place the company abstract first or close to first in line), add a graphic to the company abstract (e.g., a colored halo around the company abstract), send an alert to the investor, or the like to draw the investor's attention to the company abstract. A boost may cost one or more credits (e.g., depending on the tier of a fund), such that boosts must be strategically applied, as discussed in more detail below.

In a similar manner, the system may store requests made by the company in an outbound pending requests queue. The outbound pending requests queue may include investor abstracts or requests indicating prior recipients of the company abstract. In this manner, a company can keep track of the type and number of investors the company has contacted to review the company's abstract. As another example, the system may store requests to the company as an inbound pending requests queue. For example, the inbound pending requests queue may include investor abstracts or requests from investors requesting the company materials; however, it is contemplated that the outbound and inbound pending requests queues may be a single pending requests queue.

After operation 204, the method proceeds to operation 206 and the system determines whether the time limit for a request has been exceeded. For example, entity abstracts may only be in the pending requests queue for a certain period of time. As shown in FIG. 13, each company abstract 506a-c includes an associated time limit 520a-c displayed adjacent to the respective company abstract 506a-c. In several embodiments, the company abstracts may be presented in order of their time limits, e.g., chronologically by expiration date. For example, as shown in FIG. 13, the company abstracts are arranged horizontally side-by-side, such that company abstracts having a time limit closest to expiring would be placed to the very left of the queue. As shown, both the company abstract 506b and abstract 506c have time limits 520b and 520c, respectively, of 5 days left (e.g., 5 business days). While a time limit of 5 days is shown, other time limits are contemplated, such as, for example, a shorter or longer period of days, weeks, or months. A time limit indicates an amount of time remaining for a party to review another party's abstract before the other party's abstract is removed from the queue. By limiting the amount of time an entity abstract can sit in a queue, parties are encouraged to act more quickly and the probability a timely connection will result is increased (e.g., the probability a startup will receive timely funding is increased). However, it is also contemplated that the timing component is omitted and an entity abstract may sit in an abstract queue until the entity abstract is reviewed. As one example, a company's investor abstract or pending request queue (e.g., outgoing pending requests) may also include time limits associated with the requests, such that a company can monitor whether a request to an investor is about to expire. As one example, the company may send a boost to an investor based on the time limit for the request nearing expiration.

If the time limit for the request has been exceeded, the method 200 proceeds to operation 208, and the first party abstract is removed from the queue, and the respective first party is notified. In some embodiments, the first party abstract is removed entirely from an application on the second party's user device or other interface. In other embodiments, the first party abstract is stored as historical information accessible to a second party, for example, for the second party to review missed opportunities. The first party may be notified by a message on an application on the first party user device, an email, or other alert (e.g., a feed notification, discussed in more detail below).

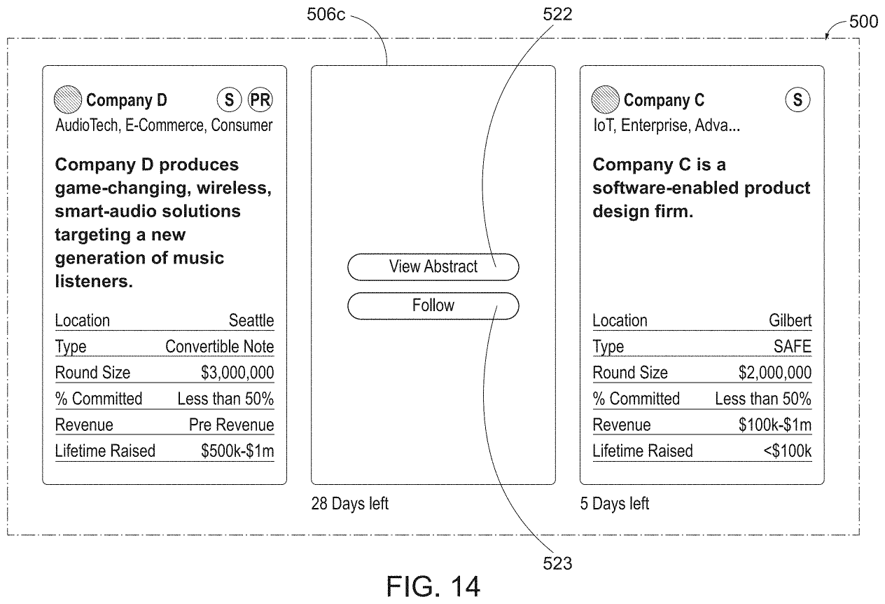

If the time limit for the request has not been exceeded, the method 200 proceeds to operation 210 and second party input is received to review first party materials for a first party abstract. FIG. 14 shows the exemplary window of FIG. 13 with a company abstract selected in the queue. As shown in FIG. 14, when the investor selected company abstract 506c, the graphic of the company abstract 506c transitioned to a graphic with selection mechanisms, a view materials or “View Abstract” button 522 to view the company materials and a tracking button 523 (e.g., with the graphic labeled “Follow”), as discussed in more detail below. The view materials button 522 may be selected to view the company materials associated with the company abstract 506c. As one example, the transition of the graphic of a company abstract to the buttons 522, 523 may be a flip; however, other transitions are contemplated. In some examples, the transition and button 522 may be omitted and an investor may select (e.g., click on) the company abstract to access the company materials.

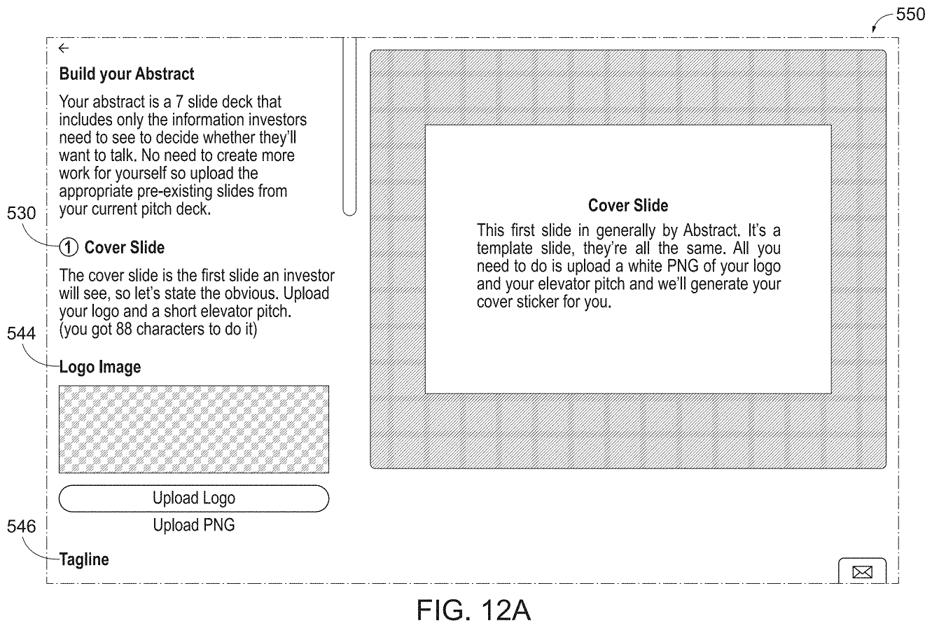

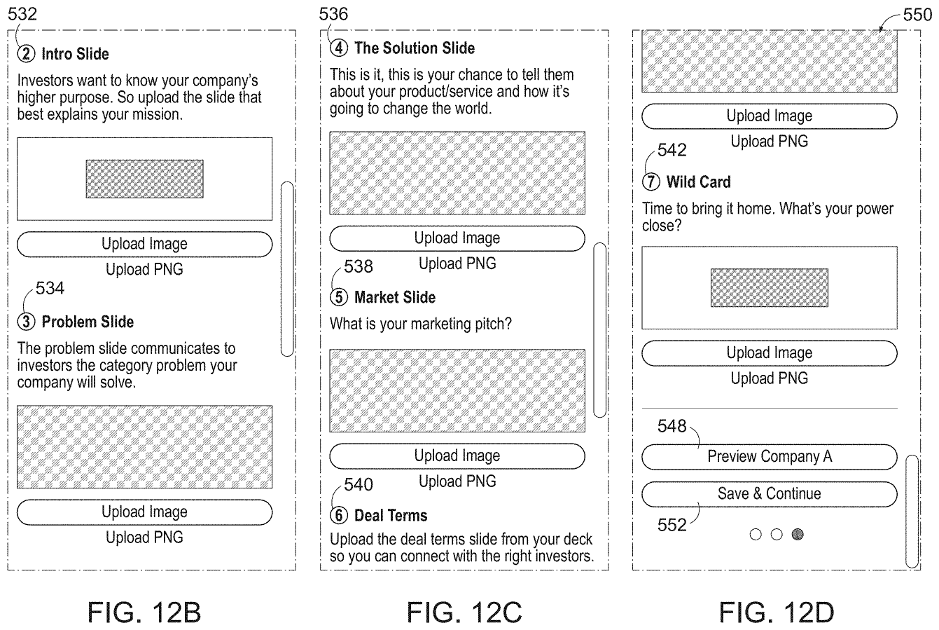

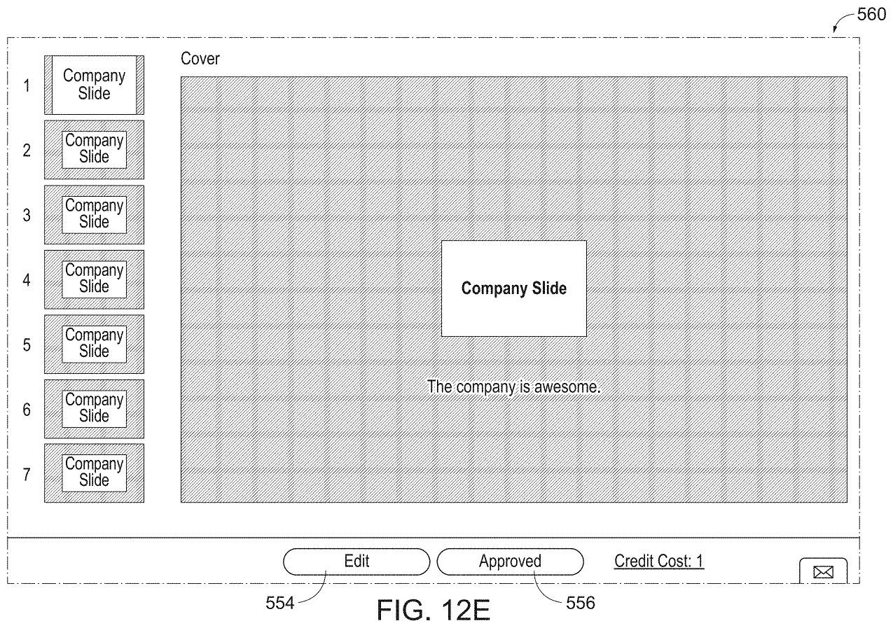

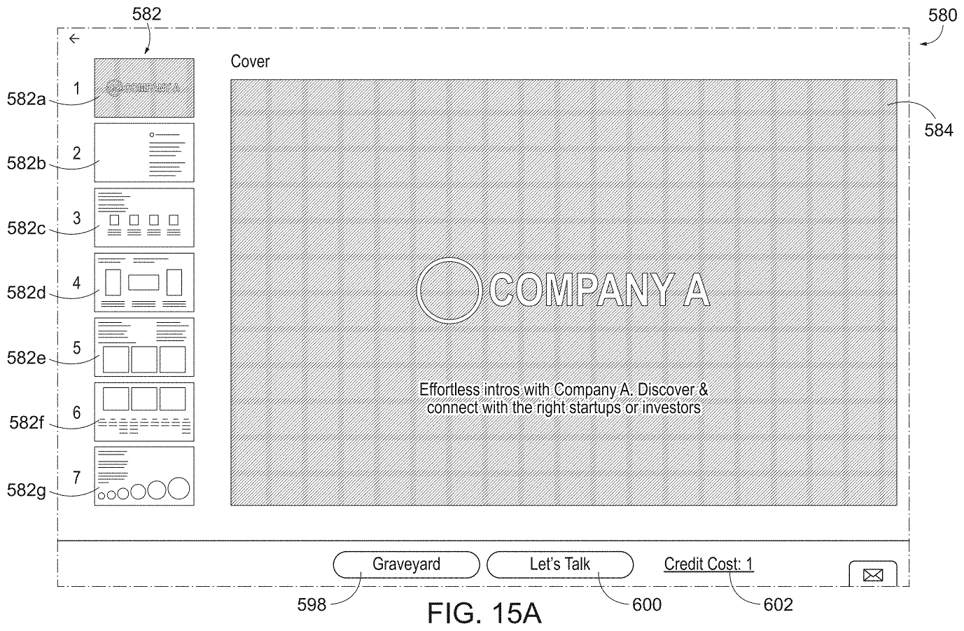

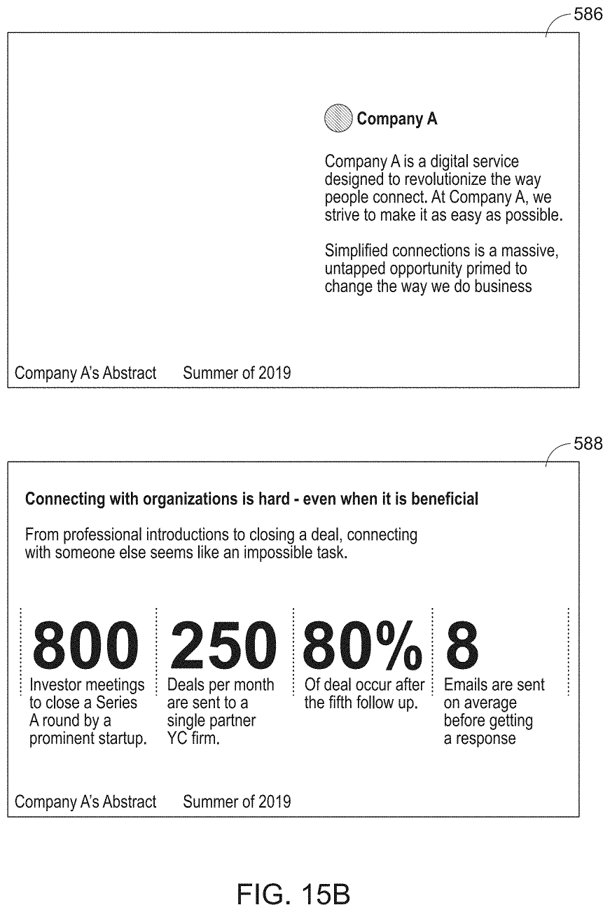

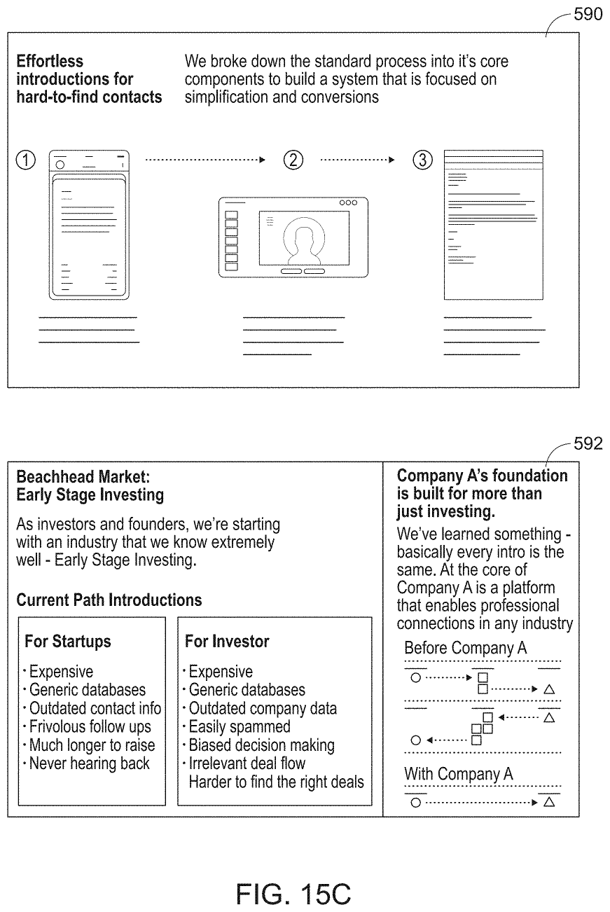

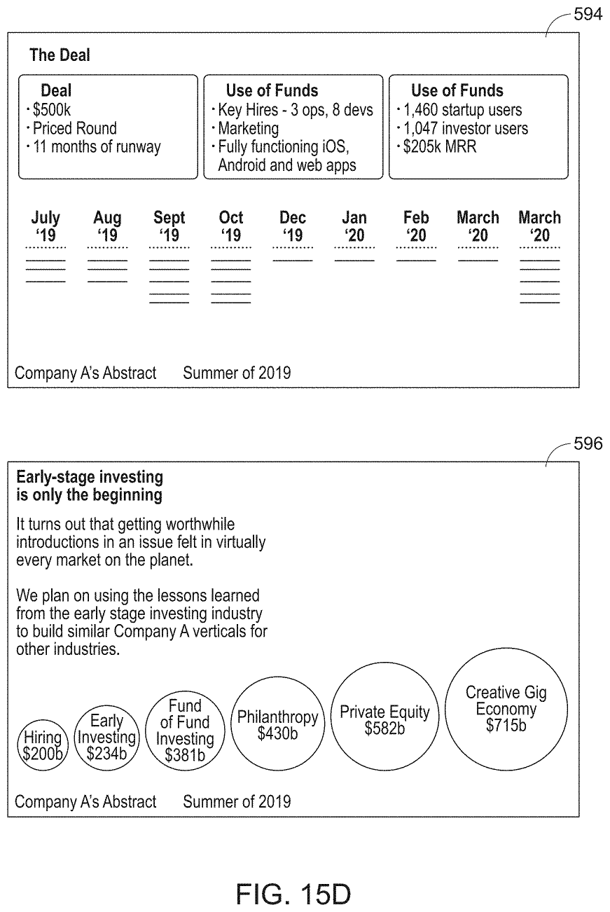

After operation 210, the method 200 proceeds to operation 212 and the first party materials are transmitted to the second party. Entity materials may include any materials, information, data, such as documents, slides, artwork, photographs, videos, sound clips, or the like. For example, job applicant materials may include a resume, writing sample, cover letter, or the like; non-profit materials may include a 501c3 application and tax documents; freelance artist materials may include art or photography samples; or the like. As one example, FIG. 15A shows an exemplary graphical user interface on an investor's user device for displaying company materials to an investor. In the depicted embodiment, the company materials are in the form of a slide deck or presentation, for example to provide a quicker and more efficient way for investors to review deal flow. An entity user may upload entity materials when the entity user sets up the entity user's account. For example, FIGS. 12A-D show a graphical user interface on a company user's device displaying an exemplary window 550 for creating company materials. The company materials include details about the company that a company user believes will be important for an investor to know or that will attract investors. For example, the company materials may be a pitch deck. In some embodiments, the system may upload slide decks (e.g., in PDF, PPT, or PNG format) input by a company user for the company materials. For example, the system may prompt the company user to upload the slide deck before filling out the company abstract, allowing the system to convert the slide deck in the back-end to individual PNG files, or other compatible files, while the company user creates the company abstract. In this example, when the company user is ready to create the company materials (e.g., edit the slide deck to fit the system requirements), the slide deck may be ready for editing due to the back end processing. In some embodiments, the system may be configured to allow the company user to create the slide decks on the user interface using the application on the company user device.

In some embodiments, the system may limit the amount of information an entity user can include in entity materials. For example, the number of slides or materials a company user can include in the company materials may be limited. As another example, the amount of information a company user can include in the slides or materials may be limited. For example, the information may be limited to a certain size slide or the slides may have a word or character limit. As another example, a job applicant may have limits on the number of writing samples or number of pages or words in a writing sample that the job applicant can include in the job applicant materials. As yet another example, a freelance artist may have a limit to the number of samples of art or photographs the artist can upload.

As one example, as shown in FIGS. 12A-D, the company materials may be limited to a predetermined number of slides. For example, as shown, the company materials may include one or more of a cover slide 530, an intro slide 532, a problem slide 534, a solution slide 536, a market slide 538, a deal terms slide 540, a wild card slide 542. Other slides are contemplated, including, for example, a team slide (e.g., providing information on the entity executives and/or employees). In some examples, one or more slides may have a template. For example, a company user may enter information that may automatically populate the template. As one example, the cover slide 530 may have a template. For example, a company user may upload a logo 544 and an elevator pitch or tag line 546 and the system may automatically generate the cover slide 530 including the uploaded information. In some examples, the elevator pitch may have a word or character limit. For example, as shown, the elevator pitch has an 88 character limit; however, other numbers of characters are contemplated. As another example, one or more slides may be created by a user and uploaded. The system may include an auto crop feature to fit the slides to a particular sized boundary.

As shown in FIG. 12B, the intro slide 532 may include information on the company's mission or other general information for the company. The problem slide 534 may include information on the problem(s) the company intends to solve. For example, the information may include a general category for the problem (e.g., pollution, overcrowding, hiring processes, etc.). The solution slide 536 may include information on the company's solution to the problem described on the problem slide 534. For example, the solution slide 536 may include information on the company's product or service and how the product or service will resolve the problem. The market slide 538 may include additional information about the company or the company user that is intended to attract an investor (e.g., a marketing pitch).

The deal terms slide 540 may include the company's proposal for one or more deal terms (e.g., pre-money valuation, post-money valuation, type of security, liquidation preference, option pool, etc.). The wild card slide 542 may be additional information provided by the company. For example, the additional information may be in the form of a slide, video, audio, picture, or the like, related to the company. After a company user has uploaded or created the one or more slides or materials, the company user can preview the company materials and/or upload the company materials. For example, as shown, the company user may select the preview button 548 and preview the company materials or select the “save and continue” button 552 to save the company materials. The company materials may be associated with (e.g., linked to) the company abstract created by the company user.

FIG. 12E shows an exemplary graphical user interface for previewing company materials before approving and/or saving them. As shown, a user may preview the company materials in a window 560 on a graphical user interface of the company device as the materials would be represented to an investor. As shown, the company user may continue to edit the company materials by selecting the edit button 554 or approve of the company materials by selecting the approved button 556. If the company user selects the edit button 554, the window 560 returns to the window 550 shown in FIGS. 12A-D. If the company user selects the approved button 556, the window 560 may change to a home window where the company user can review investor abstracts and make connections with investors.

Returning to FIG. 15A, an investor may review the company materials in a window 580 displayed on a graphical user interface on the investor's user device. For example, the company materials may be displayed with thumbnail images 582 of the slides for the investor to click through to easily locate certain information. When the investor selects a thumbnail image 582, the respective slide populates on the window 580. For example, as shown in FIG. 15A, when the investor selects thumbnail image 1 582a, a cover slide 584 is displayed in the window 580; when the investor selects thumbnail image 2 582b, an intro slide 586, e.g., shown in FIG. 15B, is displayed in the window 580; when the investor selects thumbnail image 3 582c, problem slide 588, e.g., shown in FIG. 15B, is displayed in the window 580; when the investor selects thumbnail image 4 582d, a solution slide 590, e.g., shown in FIG. 15C, is displayed in the window 580; when the investor selects thumbnail image 5 582e, a market slide 592, e.g., shown in FIG. 15C, is displayed in the window 580; when the investor selects thumbnail image 6 582f, a deal terms slide 594, e.g., shown in FIG. 15D, is displayed in the window 580; and when the investor selects thumbnail image 7 582g, a wild card slide 596, e.g., shown in FIG. 15D, is displayed in the window 580.

Returning to FIG. 4, after operation 212, the method 200 proceeds to operation 214 and the system determines whether the second party has made a positive selection. For example, after reviewing the first party materials the second party may decide whether to connect with the first party. A positive selection indicates the second party is interested in the first party and wants to connect with the first party, while a negative selection indicates the second party is not interested in the first party and does not want to connect. For example, as shown in FIG. 15A, the user interface 580 includes selection options for an investor to either connect with the company or discard the company abstract. As shown, the user interface 580 includes a delete button 598 for discarding the company abstract, in this example a graphic titled “Graveyard”, and a connection button 600 for connecting with the company, in this example a graphic titled “Let's Talk.” The delete button 598 the company abstract, when selected, provides user input to the system to execute a removal or deletion function, e.g., to delete or remove the company abstract. The button for connecting 600 with the company, when selected, provides user input to the system to execute connection or introduction functions, e.g., as discussed in more detail below.

If the second party makes a positive selection at operation 214, the method 200 proceeds to operation 220 and the system executes connection or introduction functions to connect the second party with the first party. The connection or introduction functions may be executed by generating and transmitting a communication, such as messages to the first and second parties, for example, an email, text message, video conference, phone call, or the like. As one example, the system may send an automated email introduction to the respective entity user devices. When the entity accounts are set up, the system may receive account user input to store an email and/or calendar associated with the entity account, or associated with the particular user account. The system may use the associated account email to send introductions, and in some instances, certain notifications (e.g., updates to certain associated entity abstracts) based on user account preferences. If a calendar is associated with the account, the system may use the calendar to schedule meetings between parties. The system may be able to track various metrics through the activity of the email and/or calendar associated with the account, for example, the last time an email was sent to a specific user account, when the next meeting is scheduled with a user account, the last time a meeting was scheduled with a user account, time spent without contacting a user account through email or calendar, or the like.

The introduction may be sent to the users of the first party and second party accounts; however, the recipient can be configured to include a different individual, such as, for example, an investor's assistant. As one example, an automated bot may email both the first and second parties with an automated email making an introduction. For example, the email message may read:

Hey Joe,

I'd like to introduce you to Jane. Jane is a Partner at Jane's Company. After reviewing your company materials, she is interested in talking to you more about Outpost.

Jane,

Per your request, I'd like to introduce you to Joe. Joe is the CEO of Outpost, which you mentioned wanting to chat with.

I've included both of your email addresses in this thread so please feel free to take the conversation to the next step.

Consider yourselves introduced.

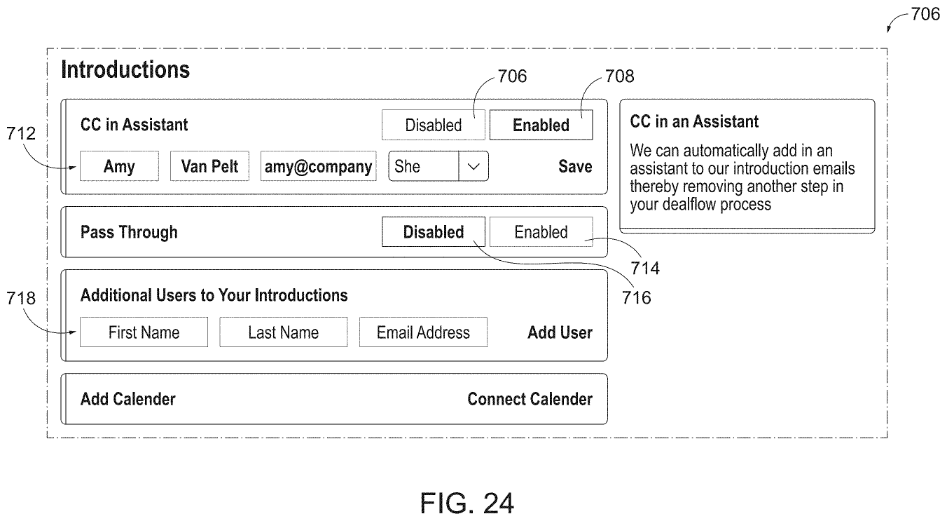

The introductions may be customizable by a user. The system may receive introductions customizations input by a user, including who receives introductions, the contact method (e.g., email, text, etc.), visibility of user contact information (e.g., whether the other user can see their email address or an anonymous user name), or the like. For example, the system may be instructed by a user to include an assistant and/or another partner and/or another partner's assistant on introductions a particular partner receives. It may be beneficial to include an assistant or access to a calendar application to expedite scheduling meetings or to keep the partner's email anonymous. FIG. 24 shows an exemplary introductions window 706 for customizing introductions. In the depicted example, the system may copy an assistant's email address on introductions when an enabled button 708 is selected or omit this function when a disabled button 710 is selected; however, other selection mechanisms are contemplated, such as a toggle for example.

The system may also receive assistant information 712, e.g. input by an account user, including, for example, name, email, gender, working hours, location, or the like. As shown, the information may be input by one or more text boxes and/or drop down menus. The system may store the assistant's information 712 associated with the user's account.

The system may omit including the account user on the introductions if the system has received omission input from the account user. As shown, a user may provide introduction omission input by selecting an enable button 714 to enable the system to bypass the user account for introductions, e.g., shown as a “Pass Through” graphic on the introductions window 706. If this feature is enabled, the system will transmit introductions directly to the assistant listed and omit the account user (e.g., if the account user wants to remain anonymous or wishes to maintain confidentiality of some contact information). If the introduction omission function is disabled, e.g., the disable button 716 is selected, then the account user is not omitted from introductions and introductions may be sent to the account user with the assistant copied.

The introductions window 706 further may allow the account user to add additional users to the introductions, e.g., by inputting the other user's information 718, e.g., name, email, gender, contact information, etc. It is also contemplated that the one or more other users may be selected by a drop down menu or other selectable element that includes other users on the account or other users the account user has previously been associated with (e.g., other investors the account user tracks). For example, a first partner may add a second partner to the first partner's introductions. If the other user (e.g., second partner) has introductions preferences selected (e.g., to copy the other user's assistant), such preferences may be applied to the introductions to the account user (e.g., the first partner). For example, if the second partner has an assistant copied on introductions, then the assistant will also be copied on introductions to the first partner.

The system may automatically generate the introduction text based on the introductions preferences. For example, if an assistant or other user is copied, the system may automatically generate text based on the inclusion that includes the assistant's or other user's name and, in some instances, gender. For example, the text may state, “I've cc'd [Assistant first name] who handles [Partner's first name] calendar. [Assistant Gender] can help you find a good time to connect.” Further, the system may allow a user to input preferences for including or omitting external links, such as a hyperlink to the account user's associated entity's website. If the link function is turned on, the system will include the link in the introduction. For example, when the system generates an introduction, the system may first sort through the user's introductions preferences, e.g., whether other users are copied, whether links should be included, and output the introduction text based on the introductions preferences. However, it is also contemplated that the system may automatically generate the introductions text when the user inputs the user preferences (e.g., as the user inputs an assistant's name to copy, the system automatically generates text introducing the assistant), and stores the text for future use when the system makes introductions. In this example, when an introduction is made, the system pulls the previously stored text to generate the introduction.

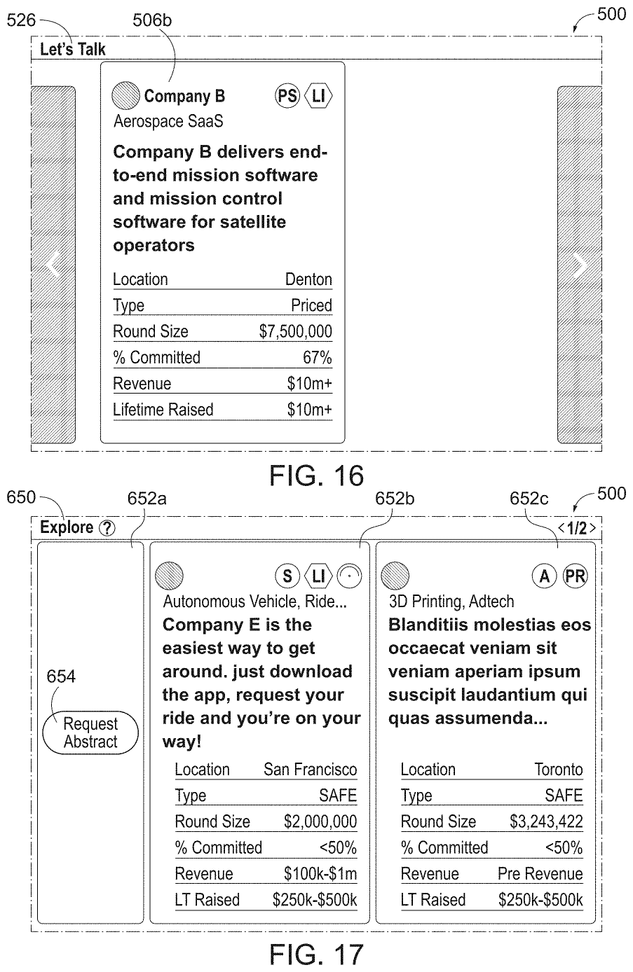

After a connection function is executed (e.g., the connection button was selected or a connection request was accepted), the system may store the first party abstract in a location for prior connections on a user interface of the second party's user device. For example, FIG. 16 shows the window 500 of FIG. 13 after the investor has connected with the company. As shown in FIG. 16, company abstract 506b moved from the pending requests queue 504 displayed on the user interface 500 shown in FIG. 13 to a new queue category indicating the investor has connected with the company, in this example a connections queue 526, displayed in the window 500. In this manner, an investor can use the system to easily locate prior connections.

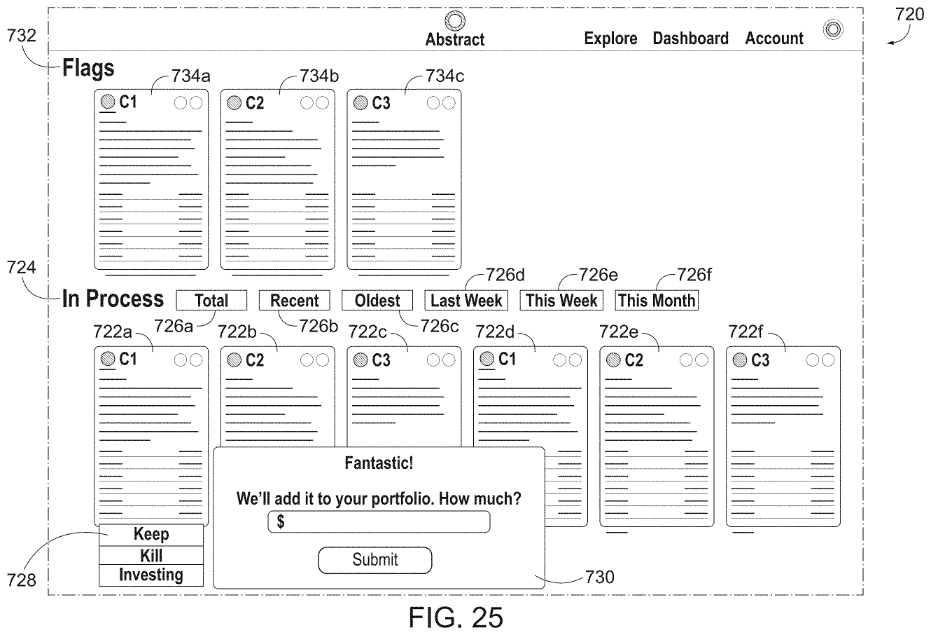

FIG. 25 shows an embodiment of a window 720 on an exemplary user interface displaying a queue for prior connections. In the example shown, entity abstracts 722a-e are organized in a connected entities queue 724, shown as an “In Process” queue in the window 720. The entity abstracts 722a-e in the connected entities queue 724 are associated with entities the entity account user has previously connected with. In this example, the window 720 includes selection features 726a-f to adjust the organization of the entity abstracts 722a-e in the connected entities queue 724, for example, to show certain entity abstracts and hide others. For example, all entity abstracts 722a-e may be displayed when the Total button 726a is selected, the most recent entity abstracts (e.g., connections within a certain amount of hours, days, weeks, months, etc., or a particular number of connections up to the most recent) may be displayed when the Recent button 726b is selected, the oldest entity abstracts (e.g., a particular number of connections or for a particular time frame from the first connection made) may be displayed when the Oldest button 726c is selected, and the entity abstracts from the prior week, current week, or current month may be displayed when the respective Last Week 726d button, This Week button 726e, and This Month Button 726f is selected. The system may store timing data for various entity behaviors (e.g., selecting a connect button, requesting company materials, etc.) as metadata associated with the entity abstract, allowing the system to sort through the entity abstracts according to the timing data.

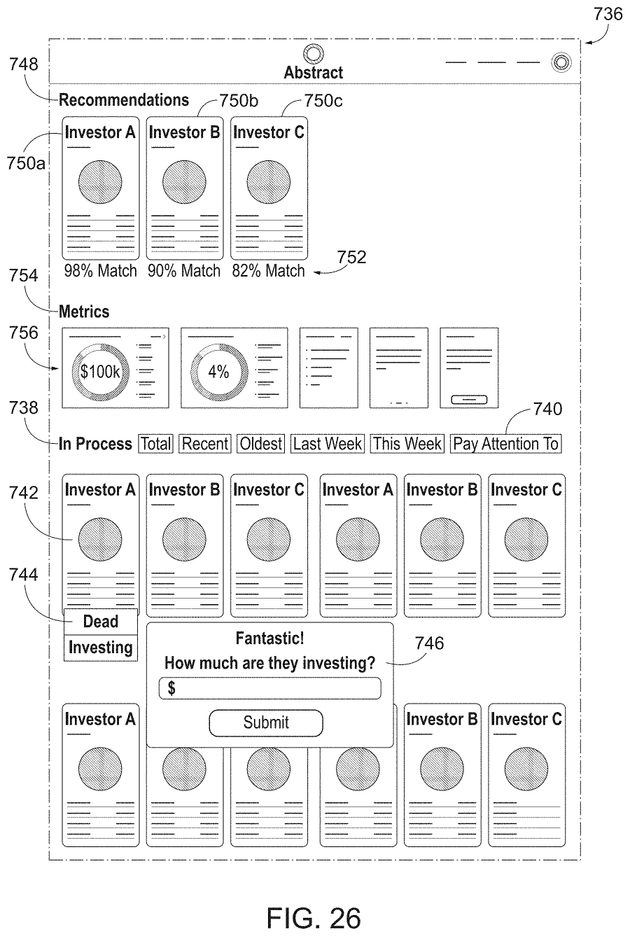

Other organization of the entity abstracts is also contemplated, for example, the window 720 may include a selection mechanism to display entity abstracts from the prior month, the newest entity accounts or display based on other entity features, or the like, or the selection mechanisms may allow specific ordering of the entity abstracts without hiding entity abstracts. It is further contemplated that the organization options may vary based on the type of entity. For example, FIG. 26 shows an exemplary window 736 displaying information on a graphical user interface of a company user device. In this example, the connected entities queue 738 includes an important abstracts button 740, in this example shown as a graphic labeled “Pay Attention To”. For example, the system may mark certain entity abstracts as important, e.g., with associated metadata. An entity abstract may be marked as important based on one or more of match/recommendation data generated by the system (e.g., entity abstracts above a certain match percentage, e.g., matching above 80%, 90%, 95%, or the like, e.g., those considered most likely to connect or engage), user input (e.g., a user may provide input to the system to mark an entity abstract as important, for example, tracked abstracts), or the like. When the important abstracts button 740 is selected, the system displays investor abstracts considered most important. While such organizational system capabilities are described with respect to the connected entities queues 724, 738, it is also contemplated that such functionality may be applied to other queues described herein, for example, pending, tracking, explore, updates, recommendations, or other queues, allowing the entity account user to more easily sort through entity abstracts in the queues.

Returning to FIG. 4, after operation 220, the method 200 proceeds to operation 222 and the system determines whether a positive second party decision regarding the first party was received. For example, once the parties have connected, the second party may decide to keep the first party under consideration, and therefore keep the first party abstract in the connection or connected entities queue, pursue or engage with the first party, or reject the first party. A positive second party decision includes keeping or pursuing the first party, while a negative second party decision includes rejecting the first party. Examples of a second party pursuing or engaging with a first party include an investor investing in a company, a hiring company, employer or project manager hiring a job applicant or independent contractor, a fund investing in another fund, an equity firm acquiring a new partner, or the like.

FIG. 25 shows an exemplary selection mechanism for the system to receive decision input on a connected entity (e.g., in the connected entities queue 724). In the depicted example, the entity abstract 722a, in this instance a company abstract, includes a drop down menu 728 with options to keep or delete the entity abstract 722a from the connected entities queue 724 (e.g., shown by a graphic labeled “Keep” or “Kill”, respectively) or engage with the entity associated with the entity abstract 722a (e.g., shown by a graphic labeled “Invest” in this example). As another example, FIG. 26 shows an exemplary selection mechanism for a company account user to input a decision on an investor. In the depicted example, the investor abstract 742 includes a drop down menu 744 with options to delete the investor abstract 742 (e.g., shown by a graphic labeled “Dead”) or engage/pursue the investor associated with the investor abstract 742 (e.g., shown by a graphic labeled “Investing”).

If a positive second party decision was received, e.g., a decision to keep or pursue the first party, the method 200 proceeds to operation 224 and the first party abstract is kept in the connection or connected entities queue or moved to the second party's engaged entities queue (e.g., shown by a graphic labeled “Portfolio”), respectively. In the example shown in FIG. 25, if the system receives input from the investor account user to keep the entity abstract 722a in the connected entities queue 724, e.g., by the investor account user selecting the option from the drop down menu 728, the system retains the entity abstract 722a in the connected entities queue 724. If the system receives input from the investor account user to engage the entity associated with the entity abstract 722a, e.g., by the investor account user selecting the option from the drop down menu 728, the system moves the entity abstract 722a to the investor's engaged entities queue. The investor's engaged entities queue (e.g., Portfolio) may include company abstracts for companies the investor has invested in or has declared investments for.

As shown in FIG. 25, when the system receives input to engage a company from an investor account user, the system generates a prompt 730 for the investor account user to input an amount to invest. In the example shown in FIG. 26, if the company account user selects Investing from the drop down menu 744, the investor abstract 742 may be moved to the company's engaged entities queue. The company's engaged entities queue may include investor abstracts the company has requested investments from or for investors that have already invested. As shown in FIG. 26, when the system receives input to engage an investor from a company account user, the system generates a prompt 746 for the company account user to input an amount to be invested. While the examples depicted in FIGS. 25 and 26 are for an investor-company connection, it is also contemplated that such features may be applied to other entities. For example, for a hirer-hiree connection, the prompt 730 may allow the hirer to input a salary, fixed fee, or timeframe for completion of the job, or the like. It is contemplated that multiple account users may be required to provide input into the second party decision before the system takes action. For example, a threshold number of investor account users may be required to engage a company, e.g., by selecting the option from the drop down menu 728, before the system moves the entity abstract 722a to the investor's engaged entities queue.

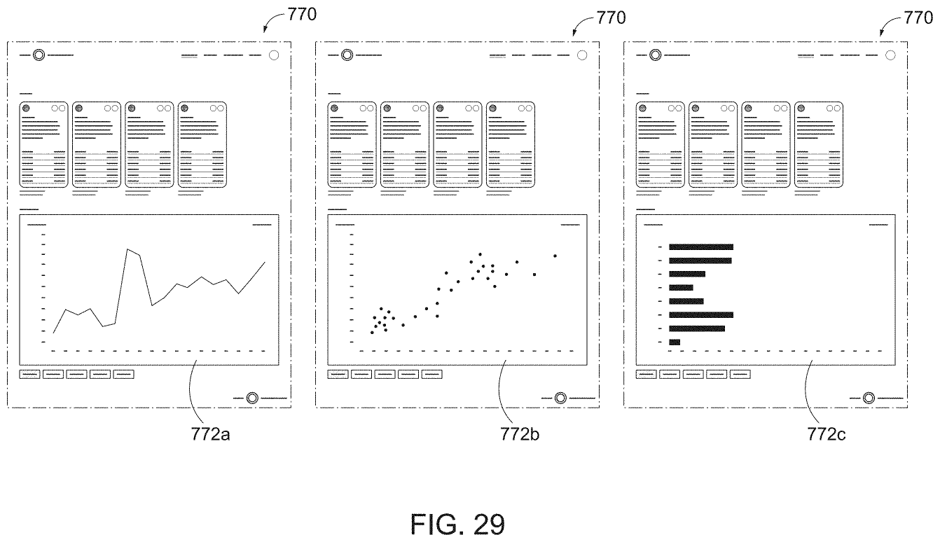

The system may continue to track entity behavior associated with engaged entity abstracts and updates to the entity abstracts. The system may generate metric data associated with engaged entities to allow the second party to track certain metrics of an engaged first party. As one example, FIG. 29 shows various charts 772a,b,c generated by the system and displayed in an engaged entities window 770 on a graphical user interface of an entity device. The charts 772a,b,c or other graphical displays or statistics may be customizable depending upon the metrics the entity account user prefers to analyze. The system may receive input from an entity account user on which metrics to display (e.g., deal flow over time, percent of round closed over time, or the like). The metrics may be displayed as a line graph 772a, scatter plot 772b, bar graph 772c, or the like. Additionally, the system may track updates to an engaged entity's abstract, and when changes are identified (e.g., changes in percent of round closed, revenue increases, etc.), the system may display the entity abstract in an updates queue (e.g., the updates queue 732 labeled “Flags” shown in FIG. 25) in the engaged entities window 770 or a tab/window associated with the engaged entities window 770, for example so that the entity account user can easily view updates for entities in its engaged entities queue.

Returning to FIG. 4, if the second party does not make a positive selection and instead makes a negative selection at operation 214 (e.g., selects the delete button 598), or the second party does not input a positive second party decision and instead inputs a negative second party decision at operation 222 (e.g., rejecting the first party), the method 200 proceeds to operation 216 and the first party abstract is discarded. For example, if at operation 214, the system receives input to delete the company abstract (e.g., by the investor selecting the delete button 598 in the window 580 shown in FIG. 15A), the system removes the company abstract from the queue displayed on the user interface (e.g., from the pending requests queue 504 displayed in the window 500 of FIG. 13).

As another example, at operation 222, if the investor inputs a delete action (e.g., selects the graphic “Kill” from the drop down menu 728 shown in FIG. 25), e.g., after connecting with the company associated with the entity abstract 722a, the system removes or deletes the entity abstract 722a from the connected entities queue 724 and stores the entity abstract 722a in a location for deleted entity abstracts. As yet another example, at operation 222, if a company inputs a delete action (e.g., selects the “Dead” icon from the drop down menu 744 shown in FIG. 26), the system removes or deletes the investor abstract 742 from the connected entities queue 738 and stores the investor abstract 742 in a location for deleted investor abstracts. For example, a company may assume a connection with an investor is dead or not progressing further if the investor never responds after an introduction and decide to discard the investor abstract.

In some instances, the system may prevent further communication between entities when an entity abstract has been deleted (e.g., when the first party abstract is stored in the deleted abstracts location by the system). However, in some instances, the system may revive or resurrect a first party abstract by removing the first party abstract from the deleted abstracts location based on second party input, e.g., by the second party spending more credits, allowing the second party to establish communication with the first party. For example, the second party may access the deleted abstracts location on a user interface of the second party user's device to provide restoration input. When the system receives the restoration input to restore an entity abstract (e.g., by the second party user selecting a resurrect button on the first party abstract), the system may move the first party abstract from the deleted abstracts location to another location for active first party abstracts, e.g., such that the first party abstract appears in the connected entities queue on a graphical user interface of the second party user's device.

The system may analyze behavioral data for entity abstracts in the deleted abstracts location and output certain metrics in a similar to the metrics discussed above with respect to engaged entities. For example, charts may display holistic data about entities the second party has discarded. As discussed above with respect to FIG. 29, the charts may be customizable depending upon the metrics the second party prefers to analyze. For example, system may receive input from the second party on which metrics to display (e.g., deal flow over time, percent of round closed over time, or the like). The metrics may be displayed as a line graph, scatter plot, bar graph, or the like. Additionally, the system may track updates to a discarded entity's abstract, and when changes are identified (e.g., changes in percent of round closed, revenue increases, etc.), the system may display the entity abstract in an updates queue located in the same location as or a location associated with the deleted abstracts location, for example so that the second party can easily view updates for previously deleted entities.

After operation 216, the method 200 optionally proceeds to operation 218 and the first party abstract may be stored as decision history. For example, an investor may want to keep track of companies the investor passed on to monitor their success. As another example, an investor or philanthropist may want to keep track of companies or non-profits that the investor or philanthropist finds interesting for future investments or charitable contributions, but which do not presently fit the investor's or philanthropist's funding strategy. The decision history may also include first party abstracts that were removed from the queue due to expiration of the time limit. The decision history may also include metadata indicating information related to the decision (e.g., the date the first party abstract was considered, date time limit expired, date declined connection, etc.). An entity may access the decision history on the user interface of the entity's user device. In some embodiments, the system may revive first party abstracts in the decision history based on second party input (e.g., by spending a credit), so that the second party may connect with the respective first party; however, it is also contemplated that the system may prevent further actions (e.g., connection) with respect to first party abstracts in the decision history. If the method 200 does not proceed to operation 218, the first party abstract is deleted from the second party's queue (e.g., removed from the application interface on the second party's user device).

### Credit System

In several embodiments, the system may include a credit system to incentivize, discourage, and/or enable entity behaviors. For example, the credit system may limit the number of connection requests available to a particular entity. An entity may be allotted a certain number of credits, which may be associated with the entity's system account (e.g., all users of the entity account share the same credits). The number of credits allotted may depend on the tier and type of plan selected by the entity (e.g., associated with the entity's system account). For example, once an entity sets up an account, the entity can purchase a plan. The system may include two or more plans, e.g., three plans (e.g., Lite, Enhanced, and Premium, from cheapest to most expensive). The plans may have different associated costs, with the more expensive plans including more system features, e.g., a greater credit allotment.

In several embodiments, a free trial period (e.g., 14 days) may be associated with one or more plans, providing an entity user the opportunity to test the system before committing to use it. During the free trial period, the system may prevent the entity user from using any credits or may allot some credits for the free trial period, e.g., five credits. For example, if the system receives input by a user to use a credit when no free trial credits are allotted or all the free trial credits have already been used, the system may generate a notification or alert indicating the use of the credit will end the free trial period, for example, a message stating, “You are attempting to use a credit which will end your free trial period” with a Continue button and Cancel button. In this example, if the Continue button is selected, the system initiates the action request input by the user and charges the user's account for the plan selected by the entity user, ending the entity user's free trial period. In this example, if the Cancel button is selected, the system refreshes the previous screen on the graphical user interface of the entity user's device.

The system may reset the credits in an entity user's account after a particular time period, e.g., credits can be allotted and reset by week, month, or bi-monthly, or as the entities transition to new benchmarks, e.g., reset between Series A and Series B funding rounds, or based on a payment plan, e.g., reset for each billing cycle. If an entity user does not use all of the allotted credits within the particular time period (e.g., within the billing cycle), the unused credits may be “lost” (e.g., removed from the account) for the next period and may not be re-activated or used. If an entity user uses all of the allotted credits during the particular time period set by the system, the system may prevent the entity user from taking actions that require a credit. For example, if the system receives input by an entity user to take an action that requires a credit and the system determines the entity user's account has a zero credit balance, then the system may send a notification or alert to the entity user indicating the entity user account is out of credits.

The system may also restrict the number of allotted credits an entity user is allowed to use (e.g., useable credits) (e.g., based on the account plan) during a particular time period (e.g., week, monthly, etc.) (e.g., a credit use period). For example, entity users with an entity account having a Lite plan may only use 25% of the total allotted credits, entity users with an entity account having an Enhanced plan may only use 50% of the total allotted credits, and entity users with an entity account having a Premium plan may use 75% of the total allotted credits during the set time frame. As one example, an entity account with a Lite plan may have 40 total allotted credits, but the entity user(s) associated with the account may only be able to use up to 10 allotted credits (e.g., 25%) per week.

In some instances, the system may add additional credits, e.g., a bonus pack, to a user account based on user input and purchase of additional credits, for example, if all allotted credits were used within the set time period (e.g., before credits are reset by the system) or all the allowed useable credits were used for the credit use period. The notification or alert may include an option to purchase more credits. As one example, the system may send a message to the entity user device stating “Your account is out of credits, please purchase a bonus pack to continue” or “Your account has used the allowed allotment for a X day period, please wait for the period to renew or purchase a bonus pack” (e.g., where X is 7). The message may include a purchase or cancel button, the purchase button providing input for the system to allot more credits to the user's account and the cancel button providing input for the system to cancel the requested action. In this example, if the purchase button is selected, the system displays a checkout page on the graphical user interface of the entity user's device. The checkout page may allow the user to purchase one or more bonus packs, depending on user preference. In this example, if the Cancel button is selected, the system refreshes the previous screen on the graphical user interface of the entity user's device. If the user purchases a bonus pack, the additional allotted credits may have a time limit to be used, for example, similar to the time limit set for the initial allotted credits (e.g., within the billing cycle) or a set amount of days (e.g., 30 days from date of purchase). The amount allotted, time limit, and cost of credits may encourage entities to be selective and quick with their actions, promoting more meaningful and timely connections.

The system may automatically deduct credits from a user's account when certain actions are requested by the user, e.g., actions related to making a connection, such as, for example, a company sending a company abstract to an investor, an investor connecting with a company, or the like. The number of credits required to initiate an activity may vary based on the activity and/or the user. In one example, the number of credits may be dynamic depending on variations in the activity and/or characteristics of the entity. For example, the system may create and execute an equation that includes a dynamic value updated based on the particular activity/entity characteristic parameters, e.g., different system activities may be given a dynamic credit cost and associated with a dynamic credit calculation equation. In some instances, it may be desirable to encourage entities with certain characteristics or credentials to take particular actions by reducing the cost (e.g., credits) of those the actions, while discouraging entities with certain characteristics or credentials from taking other actions by increasing the cost of those actions. The dynamic credits may vary based on characteristics associated with the entities or based on other preferences to be encouraged/discouraged by the system.

The system may dynamically adjust credits associated with an activity or transaction (e.g., interaction with another entity such as connection, engagement, etc.) based on one or more of activity type, entity characteristics, entity behaviors, trend data, or the like. The system may associate certain activities with dynamic credits, such as, for example, boosting an abstract in a search engine or to a specific entity, buying more time, requesting a trending abstract, or the like. The credits may vary based on activity parameters, for example, an amount or time frame (e.g., buying more time to keep an abstract in another entity's pending requests may cost more credits for more time purchased, boosting an abstract to appear in top 5 search results may cost more than boosting the abstract to appear in top 10 search results, etc.). The dynamic credits may vary based on entity characteristics (for the entity taking the action and/or the entity receiving the action), such as, for example, entity ranking (e.g., tier of fund, region, time, entity-specific traits (e.g., percent of round closed for a company), or the like, or any combination thereof. As one example of credits varying based on the receiving entity characteristics, requesting an abstract from a company with a greater percent of round closed may cost more than from a company with a smaller percent of round closed. The dynamic credits may also vary based on trend data (e.g., how the entity ranks compared to other entities, based on location trends, etc.). For example, boosting or requesting an entity abstract in a region with a greater amount of entities and/or a greater amount of trending entity abstracts may cost more credits than boosting or requesting an entity abstract in a region with limited entities and/or fewer trending entity abstracts (e.g., to incentivize more interaction where there are fewer entities).

Further, the credits may be charged to one or both entities. For example, the following actions, without limitation, may be charged to a company account (or other first entity account): company sending abstract to specific investor (e.g., cost of 1 credit); investor requesting abstract and company sending abstract to respective investor (e.g., cost of 1 credit); company accepting a request to connect (e.g., cost of 1 credit); company boosting an abstract sent to an investor (e.g., dynamic credit cost based on tier of funding); company boosting an abstract in a search engine (e.g., dynamic credit cost based on region and time); company buying more time in a specific investor's queue (e.g., dynamic credit cost based on tier of fund and time); or the like. As one example, if the company does not send the abstract upon request or the company does not accept a connect request, no credits are charged.

As another example, the tracking investor actions (or other second party actions), without limitation, may be charged to an investor account (or other second party account): connecting with a company received an abstract from (e.g., cost of 1 credit); requesting a connection with a company that did not send an abstract and company accepts (e.g., cost of 1 credit); requesting and receiving an abstract from a company (e.g., cost of 1 credit); requesting an abstract from a company that denies the request (e.g., cost of 1 credit); requesting and receiving regionally trending abstract (e.g., dynamic credit cost based on region; credit determination can be multivariate); requesting and receiving nationally trending abstract (e.g., dynamic credit cost based on region; credit determination can be multivariate); requesting and receiving an abstract from a company with a certain percentage of round raised (e.g., >85% of round raised) (e.g., dynamic credit cost based on percentage of round closed); tracking a company (e.g., cost of 1 credit); or the like. As one example, an investor is not charged if the investor receives an abstract and does not connect with the company or if the investor requests to connect with a company and the company does not accept. In other words for certain actions, a party initiating the action may not be charged a credit unless the action is completed, e.g., the other party accepts.

In one example, the system may deduct a credit from the second party's account when the second party connects with the first party. As shown in FIG. 15A, a credit cost indication 602 is displayed in the window 580 indicating the cost for selecting the connection button 600. In the example shown, connecting with a company costs the investor one credit. The system displays credits on a user interface of an entity device and updates the credits display when credits are deducted or allocated, allowing an entity to keep track of the number of credits remaining (e.g., enabling the entity to take actions towards connecting with other parties). For example, as shown in FIG. 13, a credit tracker 524 is displayed in the window 500 indicating the number of credits remaining. Prior to connecting with the company, as shown in FIG. 13, the credit tracker 524 indicated 5 credits were remaining. After the investor has connected with the company (e.g., after the connection button 600 shown in FIG. 15A was selected), the credit tracker 524 will update and indicate 4 credits are remaining (e.g., due to 1 credit being spent by selecting the connection button 600). The system may also display credits as pending, for example when an action has been taken that requires an action by another party (e.g., acceptance of a request) before the credits are charged.

### Verifying Account Users

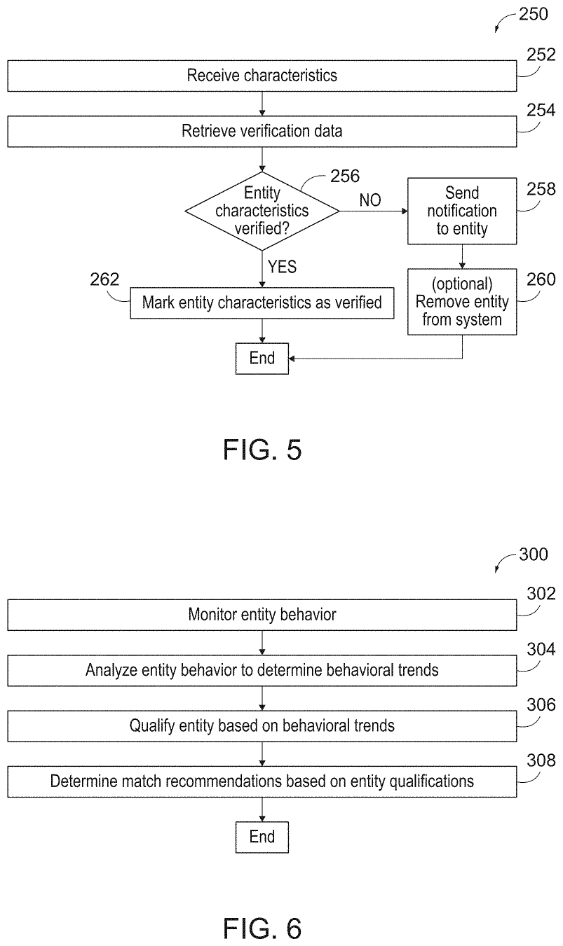

FIG. 5 is a flow chart illustrating a method for verifying entity characteristics. The method 250 begins with operation 252 and entity characteristics are received. For example, entity characteristics may be input by an entity user via an entity user device. As one example, company or non-profit organization characteristics may include one or more of identifying information, (e.g., name, address, EIN number, year founded, type of formation, 501c3 status, etc.), financial information (e.g., revenue, lifetime funds raised, percent committed, round size, tax information, etc.), and other information related to the business (e.g., field, products, processes, market, etc.). As another example, job applicant, independent contractor, client, or mentor/mentee characteristics may include one or more of identifying information (e.g., name, address, email, date of birth, gender, place of birth, etc.), education history, job history, criminal history, credit history, or the like. As yet another example, fund, equity firm, or investor characteristics may include one or more of fund size, identifying investor information (e.g., name(s), email(s), age(s), association(s), etc.), prior investments (amount, type, and entity invested in), or the like.

After operation 252, the method 250 proceeds to operation 254 and verification data is retrieved. Verification data may include data on the entity characteristics received from a source other than an entity user. For example, verification data may be retrieved from a database including information related to the entity.

After operation 254, the method 250 proceeds to operation 256 and the system determines whether the entity characteristics are verified. For example, if the entity characteristics match the verification data, the system may verify the entity characteristics. As one example, the entity characteristics are verified when the entity characteristics match the verification data above a threshold value. For example, the entity characteristics may be verified when they match at least 40%, 50%, 60%, 70%, 80%, 90%, or 100% of the verification data.

If the entity characteristics are verified, the method 250 proceeds to operation 262 and the entity characteristics are marked as verified. For example, as discussed above, the system may generate an entity abstract based on the entity characteristics. The system may also label the entity abstract as verified. For example, the entity abstract may be assigned a badge that indicates the entity characteristics are verified.

If the entity characteristics are not verified, the method 250 proceeds to operation 258 and a notification is sent to the entity device. For example, the entity may be notified by an email, text, system message, or other alert on the entity device that the entity characteristics could not be verified.

After operation 258, the method 250 optionally proceeds to operation 260 and the entity may be removed from the system. For example, the entity user's account may be disabled or locked. The entity user's email address and/or phone number may be stored in a list of unverified users, preventing the entity user from creating a new account with the same email address and/or phone number.

### Match Recommendations

FIG. 6 is a flowchart illustrating a method of determining match recommendations based on entity behaviors. The method 300 begins with operation 302 and entity behavior is monitored. For example, as an entity takes certain actions, the system tracks the actions and stores data related to the actions. The system may incorporate a timing component as the system monitors entity behaviors. For example, the system may determine an amount of time that lapses before an entity takes action or the amount of time it takes an entity to perform an action. In some embodiments, behaviors monitored by the system may include, but are not limited to, number and type of received entity abstracts; number, type, entity characteristics, deal or contract terms, or other qualities of entities a second entity connects with and/or discards; time an entity spends reviewing other entity abstracts; number and types of updates to abstracts; time an entity takes to connect after reviewing other entity abstracts and/or materials; or the like. As one example, behaviors monitored for an investor may include the number, type, company characteristics, and/or deal terms of companies an investor invests in after connecting; investor verticals; or the like.

After operation 302, the method 300 proceeds to operation 304 and the entity behavior is analyzed to determine behavioral trends. Behavioral trends may include, for example, the probability an entity will take a certain action, average time to initiate or complete an action, or the like. For example, behavioral trends may include response rate; hit (or selection) rate based on one or more entity characteristics (e.g., vertical, stage, and/or location of startup, etc.); percent of connections made from received entity abstracts; percent of lapsed time limits to review received entity abstracts; time spent reviewing accepted entity abstracts (e.g., where connected) vs. time spent reviewing discarded entity abstracts; probability of connecting; average time to connect based on location; average time to connect based on entity characteristics, type, and/or deal or contract terms; location with greatest number of connections; entity with greatest number of connections; rate of connections; or the like. The behavioral trends may vary based on the type of entity. For example, for investors and companies, behavioral trends may include percent of investments made from connections and/or from received company abstracts; probability investor invests after connecting with companies; hit rate for companies that close their round; or the like.

After operation 304, the method 300 proceeds to operation 306 and an entity is qualified based on associated behavioral trends. For example, entities may be ranked based on their type and amount of activity or interactions with other parties. For example, an entity with a high connection rate may have a high rating. For example, such an entity may be considered a “red hot” or “active” entity. As an example, a company with a high connection rate may be considered a “red hot” company and an investor with a high connection rate may be considered an “active” investor. As another example, an investor with a high probability of connecting with IT companies may be qualified as an IT investor. It is contemplated that there are many ways the system can qualify and rank entities based on their behavioral trends. It is also contemplated that entity rankings may incorporate external ranking systems, for example, by the system pulling ranking information from external databases. For example, a company may be ranked by a national ranking system, e.g., Fortune, Forbes, etc. Such company rankings may be incorporated into the system, for example, to indicate the quality of the company for a job application. The entity ranking or qualification may be stored by the system or displayed with the entity abstract. For example, the ranking or qualification may be a badge, text, a graphic (e.g., a red hot halo around the abstract), or the like.

After operation 306, the method 300 proceeds to operation 308 and the system determines match recommendations based on entity qualifications. For example, the system may recommend matches between entities with similar or the same qualifications. For example, the system may recommend a match between a red hot company and an active investor. As another example, the system may recommend a match between a company in a seed round and an investor that is qualified as a seed round investor based on the investor's behavioral trends. As yet another example, the system may recommend a match between a highly pursued job candidate (e.g., based on number of hits) and a well ranked company (e.g., based on number of hits and/or national rankings).

In several embodiments, the match recommendation may depend on one or more input variables or metrics. For example, for a match recommendation for a company searching for an investor, the input variables or metrics may include investor history and characteristics, general variables, and platform data. For example, investor history and characteristics may include investor verticals, connection rate (percent of connections per abstracts received), probability of connection, investor rating (e.g., based on time to review abstracts, connection probability, hit rate for companies closing their rounds, etc.), investor preferences (e.g., favored verticals, rounds, regions, etc. based on activity), network effect (e.g., whether investor shares/passes along deals with other investors), success rate (e.g., probability investor invests following connection), or the like. As another example, general variables may include round stage, type of investment, percent committed, connection rate (e.g., success rate of companies with the same verticals getting a connection request), vertical, location, lifetime raised to date, average time to respond, vertical hit rate, response rate, average check size per amount still open, region, fund size(s), round type, revenue, accelerator, lead investor, or the like. As yet another example, platform data may include data on regions having heavy vertical-specific investment, investor type (e.g., angel vs. fund vs. accelerators), average connection time based on region, supply and demand (e.g., number of startups and amount of funding needed vs. number of investors) (e.g., by vertical, region, type, etc.), deal terms variance (e.g., by region, investor type, vertical, etc.), or the like.

As another example, for a match recommendation for an investor searching for a company, the input variables or metrics may include investor history, market data, recent abstract changes, general variables, and platform data. Investor history may include abstract search history (e.g., by verticals, regions, etc.), speed to review abstracts based on vertical (e.g., showing vertical intellectual preference), connection probability (e.g., based on vertical, region, etc.), or the like. Market data may include similar investor preferences (e.g., abstracts similar investors review), regional focus for verticals based on market data (e.g., more deals for companies in a select market are in a particular region), number of company abstract requests over time (e.g., over days, weeks, or months), consistency of abstract requests (e.g., abstracts requested by investors that historically requested similar or the same abstracts), competition (companies having same or similar vertical or values), or the like. A similar investor may be an investor having one or more similar characteristics, assets under management (AUM), connection rates, verticals, or the like. Recent abstract changes may include new company abstracts, badges (e.g., accelerator badge, lead investor badge, etc.), accelerator rating (e.g., Y Combinator vs. TechStars, vs. Boomtown), committed amount changes (e.g., amount and rate of change), round size changes, lead investor addition, lead investor rating, or the like. General variables may include location, round stage investing in, type of investments, hit rate, vertical, number of partners, AUM, average response time, ratio of requested to received abstracts, percentage of abstract requests in company's vertical, percentage of connection requests in company's vertical, response rate, or the like. Platform data may include hit rate for vertical of company, hit rate for stage of company, hit rate for location of company, trend of vertical, trend of location, number of startups (e.g., in vertical, location, and/or stage), supply and demand (e.g., number of startups and amount of funding needed vs. number of investors) (e.g., by vertical, region, type, etc.), deal terms variance (e.g., by region, investor type, vertical, etc.), or the like.

In several embodiments, the match recommendations may be transmitted to each entity device. In some embodiments, the system may output a graphic display on an entity user's device that allows the entity to swipe left to pass on the match recommendation or right to accept the match recommendation (or vice versa). As one example, if a first party (e.g., company) accepts the match recommendation, the system may transmit the first party's abstract to the matching second party based on the first party input (e.g., investor). As another example, if the second party (e.g., investor) accepts the match recommendation, the system may send a request to the first part (e.g., company) for the first party abstract or may directly transmit the first party materials to the second party based on the second party input. In some embodiments, an entity abstract may be transmitted as part of the match recommendation. As shown in FIG. 17, the graphical user interface 500 on the investor's device includes an explore queue 650 that includes company abstracts 652a,b,c for the investor to browse through. These company abstracts 652a,b,c may include abstracts recommended by the system based on the determined match recommendations. The investor can browse through the company abstracts 652a,b,c in the Explore queue 650 and request company materials if desired, for example by selecting a request materials button 654, depicted as a “Request Outpost” icon, on the respective company abstract 652a,b,c.

In the example shown, the investor has selected the first company abstract 652a, and the graphic of the company abstract 652a has transitioned to a graphic including the request materials button 654. As another example, FIG. 26 shows a recommendations queue 748 on an exemplary window 736 of a user interface for a company user device. In this example, the recommendations queue 748 stores the investor abstracts 750a,b,c recommended by the system based on the determined match recommendations. As shown, the recommendations queue 748 displays the match results 752, e.g., the percent match, between the company and the investors associated with the respective investor abstracts 750a,b,c. As one example, the percent match may indicate the likelihood the investor will connect with or invest in the company, for example, based on behavioral trends of the investor (e.g., prior deal flow and similarities of the company with past companies the investor connected with or invested in).

### Entity Information Updates

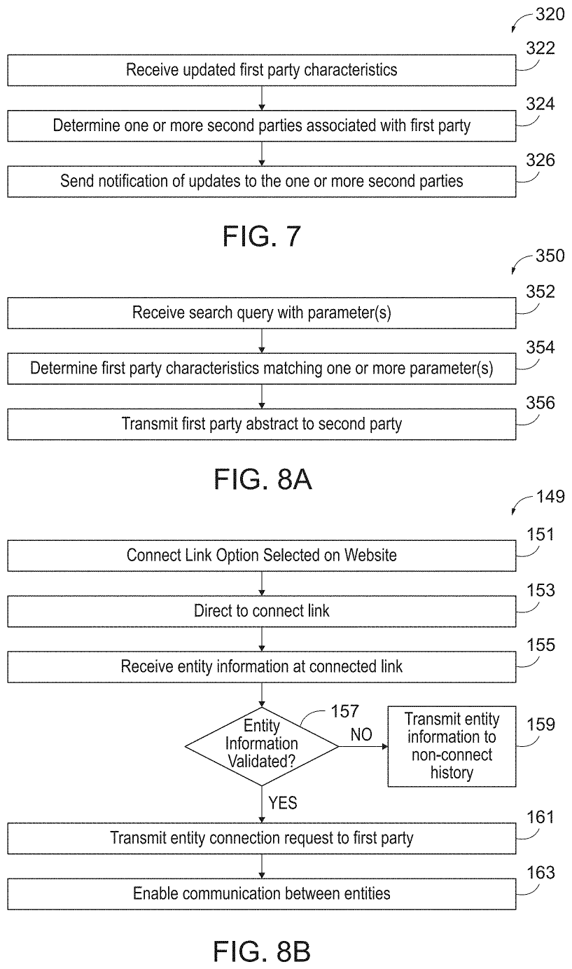

FIG. 7 is a flowchart illustrating a method of notifying entities of other party information updates (e.g., notifying investors of updates to company characteristics). The method 320 begins with operation 322 and updated first party characteristics are received. For example, updated first party characteristics may be input by a first party user, received from one or more databases, or determined by the system. Updates may be any changes to first party characteristics, such as, for example, changes to identifying information (e.g., company name, address, type of formation, etc.), financial information (e.g., round stage, type of investment, round size, amount or percent committed, revenue, lifetime funds raised, etc.), or the like.

As one example, one or more first party characteristics may be received from a database. For example, the system may periodically pull information or pull information upon request (e.g., an investor request) from a database including first party information to determine whether the first party characteristics have changed. If the system determines the first party information in the database does not match the first party characteristics in the system, the system may pull the information from the database and update the first party characteristics accordingly. In some examples, the system may notify the first party first to verify the data in the database is up to date before updating the first party characteristics.

As yet another example, one or more updated first party characteristics may be determined by the system. For example, as discussed, the system may monitor one or more behaviors associated with the first party's abstract, and analyze the one or more behaviors to determine behavioral trends that may be translated into qualifications or rankings. In some embodiments, the behavioral trends and/or qualifications or rankings are stored as one or more first party characteristics. As the system continues to monitor these behaviors, the system may determine changes in the behavioral trends and/or qualifications or rankings and update the first party characteristics accordingly.

After operation 322, the method 320 proceeds to operation 324 and one or more second parties associated with the first party are determined. Second parties associated with the first party may include second parties that have received the first party's abstract. For example, second parties having the first party's abstract in their queue are associated with the first party. In some embodiments, the first party may have a list of preferred second parties stored with the system (e.g., a company may have a list of preferred investors the company has connected with in the past or received funds from). As one example, the first party user may enter contact information (e.g., an email address) for a second party the company is familiar with to invite the second party to the platform. If the second party creates an account, the second party may be considered an associated second party. The system may store associations between entities in a database or as metadata associated with entity accounts.

As yet another example, entities may be considered “associated” if one or both entities follows or tracks the other. As shown in FIG. 14, when an entity selects another entity's abstract, a tracking button 523 may be displayed, shown by a “Follow” icon; however, it is also contemplated that the tracking button 523 may be viewable on the entity abstract without needing to first select the entity abstract. The tracking button 523 provides input to the system to perform tracking functions, e.g., to monitor entity behaviors associated with the entity abstract and/or updates to the entity abstract and provide updates to the entity that requested the tracking function. When an entity selects the tracking button 523 for an entity abstract, the system may move the entity abstract to a new location on the graphical user interface 500, for example a tracking queue or tab, e.g., indicated by a “Following” or “My List” label. The system may send an alert or notification to the entity associated with the entity abstract indicating the entity that is tracking them. For example, by tracking a company, an investor can track the company without requesting the company materials or discarding the company. When the investor requests company materials for a company abstract already in the tracking queue, e.g. by selecting the “View Outpost” button 522 shown in FIG. 14, the system may move the company abstract to a new location on the graphical user interface, for example an outgoing pending requests queue. In this example, if the company accepts the investor's request for company materials, the system may move the company abstract to the investor's connected entities queue, while if the company denies the investor's request, the system may remove the company abstract from the investor's tracking queue such that the investor can no longer view the company abstract. In some embodiments, the tracking button 523 may be located on the graphical user interface 580 shown in FIG. 15A, for example, positioned proximate the delete button 598 and the connection button 600. The tracking button 523 may provide an alternate option after viewing the company materials, for example, if the investor only wishes to invest once the company has reached a certain milestone.

After operation 324, the method 320 proceeds to operation 326 and the system sends a notification to the one or more associated second parties. For example, the system may send an email, text, system message, or other alert to the second party to notify the second party that the first party characteristics have been updated. In some embodiments, the system may transmit an updated first party abstract to the second party to replace the existing first party abstract. In an alternate embodiment, the system may directly update the existing first party abstract (e.g., in the second party's queue) with the updated first party characteristics.

In some embodiments, the system may display updated entity abstracts in an updates category or queue, for example to have an organized location on the graphical user interface for a user to view updates. For example, as shown in FIG. 25, the window 720 displays an updates queue 732, shown by a graphics labeled “Flags”. The updates queue 732 includes updated entity abstracts 734a,b,c. For example, the second party may want to track certain updates, including, for example, one or more of changes in whether the round is open or closed, type of round, round size, percent committed, revenue, whether an accelerator has been added, whether a lead investor has been added, or the like. As an example, an investor may like a company, but only desire to invest once the company has reached a certain percent committed. By easily tracking the company in the updates queue, the investor can timely invest when the percent committed is achieved. As another example, an updates queue for a company may include investor abstracts. The investor abstracts may have associated connect request likelihoods, for example a percent chance the company will get a connect request from the investor associated with the investor abstract. The updates queues may be specific to entity abstracts that have already been reviewed and placed in a particular category, for example previously engaged entities or previously deleted entities. In this example, an updates queue may be at the same location as or in a location associated with the location for engaged entities or deleted entities, such that a user can easily view updates to previously engaged or previously deleted entity abstracts.

### Searching Functionality

FIG. 8A is a flowchart illustrating a method of matching entities (e.g., companies and investors, job applicants and hiring companies, funds, or the like) based on search queries. The method 350 begins with operation 352 and a search query with parameter(s) is received. For example, a second party may input one or more parameters (e.g., entity characteristics) to search for a first party meeting the second party's preferences. For example, an investor may input one or more parameters to search for a company meeting the investor's preferences. The one or more parameters may be values for the one or more company characteristics discussed previously (e.g., location, round stage, type of investment, round size, amount or percent committed, revenue, lifetime funds raised, etc.).

After operation 352, the method 350 proceeds to operation 354 and first party characteristics matching the one or more parameters is determined. For example, the system may analyze stored first party abstracts and metadata associated therewith to determine first parties that match the second party's search results.

After operation 354, the method 350 proceeds to operation 356 and one or more first party abstracts having matching first party characteristics are transmitted to the second party. For example, the one or more first party abstracts may be displayed as a search result on a graphical user interface of the second party's user device. For example, an investor may input the search query to determine one or more matching companies that match the investor's preferences (and vice versa), a job applicant may input the search query to determine a matching company (e.g., startup or other private equity firm) (and vice versa), a philanthropist may input the search query to determine a matching non-profit organization (and vice versa), a project manager or other employer may input the search query to determine a matching independent contractor or freelance artist (and vice versa), a mentee may input the search query to determine a matching mentor (and vice versa), a fund manager may input the search query to determine a matching fund (and vice versa), or the like.

In some embodiments, an entity may boost or otherwise increase visibility of the entity abstract in a search engine. A boost draws attention to the entity abstract within the search results. For example, a boost may result in the entity abstract being displayed first or at the beginning of the search results, having an associated graphic (e.g., a colored halo or border around the abstract), or the like. In some examples, a boost may highlight the entity abstract in the search results when the entity abstract matches the search query. In some examples, a boost may highlight the entity abstract in the search results when the entity abstract partially matches the search query (e.g., not all entity characteristics match the query). For example, either an investor or a company may boost their respective abstract to the other party. A boost may cost one or more credits (e.g., depending on region, time, etc.), such that boosts must be strategically applied.

### Quick Connection

In some embodiments, the system 100 may enable a bypass through conventional queue based matching. FIG. 8B illustrates a method 149 for a quick connection function. With reference to FIG. 8B, in one example, the method 149 may include operation 151 and a connection link option is selected on a website or other platform (e.g., application, social medial page, or the like) corresponding to a first entity. The connection link may direct to a URL that includes a quick connection option, e.g., https://sendabstract.com/investorname. The connection link specifies the user name or other information corresponding to the first party, such that information entered in via the link can be linked with the first entity as the desired receiving party.

In operation 153, once the connection link is selected, the corresponding page or information located at the URL is loaded on the user device. The corresponding page at the connection link allows the user to enter information corresponding to his or her entity, e.g., enters in entity characteristics. As with method 300, the entity characteristics may be entered in directly, selected from a field, or the like. After the user has completed entering the entity characteristics, the method 149 proceeds to operation 155 and the entity information is received by the server via the connection URL.

In operation 157, the entity characteristics are validated or matched with the first party (e.g., the connection link host). For example, the system 100 may determine whether the entity characteristics match investment characteristics for the first entity. The matching or validating analysis may utilize similar techniques to those described herein.

If in operation 157, the system 100 determines that there is not a match or the second entity information is not validated for the first entity, the method 149 proceeds to operation 159 and the second entity information may be discarded and/or may be stored in a connection history (e.g., graveyard) for the entities. For example, if a Startup A uses the connect link option to connect with Investor B, but Startup A does not satisfy the validation for Investor B, then Startup A's abstract may be transmitted directly to the discarded history for Investor B. Investor B may not receive a notification regarding the discarding, but will be able to review his or her history to see that a request was attempted.

If in operation 157, the system 100 determines that the second entity is validated or matched with the first entity, the method 149 proceeds to operation 161 and a connection request may be transmitted between the parties. For example, the system 100 may transmit the requesting entity's abstract or other information. Alternatively, the method 149 may bypass operation 161, and proceed directly to operation 163 where communication is enabled through the platform between the entities.

In some embodiments, the system may limit the number of connection links that a particular entity can select. For example, each connection link selection may require a credit or token to help reduce the number of “bypasses” allowed by the system, but still providing some bypass options via the quick connection link.

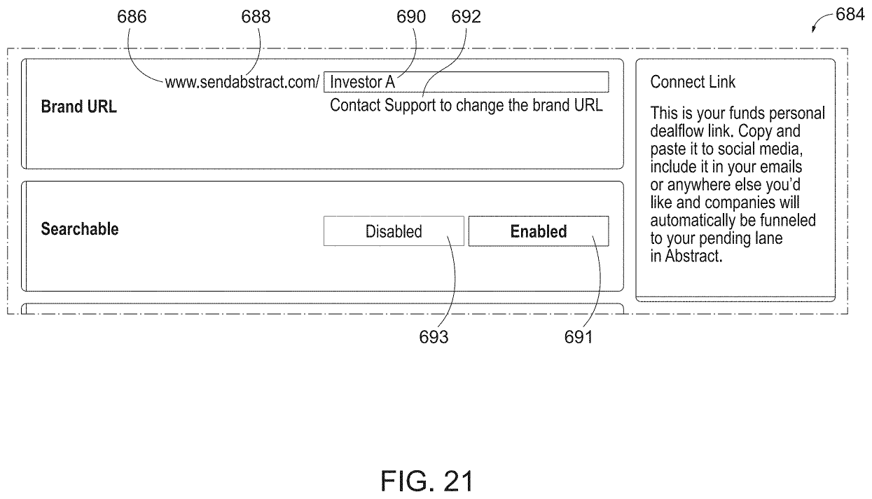

Examples of generating a connection link are shown in FIG. 21, where a user can generate an individualized connection link URL that may be used as part of the method 149.

### Information Exchange

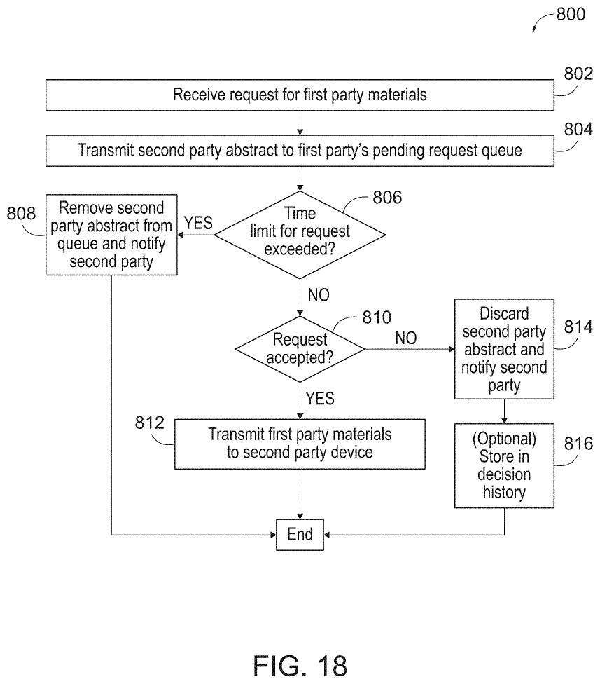

FIG. 18 is a flowchart illustrating a method of exchanging information between entities. The method 800 begins with operation 802 and a request for first party materials is received. The request may be received by second party input into the system. For example, a second party may browse first party abstracts on a graphical user interface of the second party user device and, after finding a first party of interest, select a button or icon on the user interface to request to see the first party materials. As one example, an investor may request a company's first party materials, e.g., slide deck. As shown in FIG. 17, an investor may make a selection from a company abstract 652a in an explore queue 650 on a graphical user interface 500 of the investor's user device to request company materials from the respective company.

After operation 802, the method 800 proceeds to operation 804 and the second party abstract is transmitted to the first party's pending requests queue displayed on a graphical user interface of the first party's user device. In the above example, the system may display the investor abstract in the pending requests queue on a graphical user interface of the first user device. Additionally or alternatively, the system may send the request to the first party as a notification (e.g., feed notification) or message (e.g., email, text, etc.).

After operation 804, the method 800 proceeds to operation 806 and the system determines whether a time limit for the request has been exceeded. For example, outstanding requests may only be pending for a particular time frame, e.g., a period of hours, days, weeks, months, etc. As one example, the system may time stamp the second party abstract (e.g., with timing metadata) when it is first placed in the pending requests queue. The system can track the length of time the second party abstract is in the pending requests queue to determine when the time limit for the request has been exceeded, e.g., by comparing the time pending to a threshold pendency time allowed.

If the system determines the time limit is exceeded at operation 806, the method 800 proceeds to operation 808 and the system removes the second party abstract from the pending requests queue and notifies the second party. For example, the system may discard the second party abstract and store the abstract in the deleted abstracts location. The system may notify the second party by a feed notification or message that the abstract was removed and/or time limit was exceeded.

If the system determines the time limit has not been exceeded at operation 808, the method proceeds to operation 810 and the system determines whether the request for first party materials was accepted based on first party input. For example, the first party may review the second party abstract displayed in the pending requests queue. As one example, a startup company may review an investor abstract, which may include information about the investor's funds, prior investments, or the like. The investor abstract may also include trend data determined by the system. For example, the investor abstract may include a percent response rate, a percent likelihood the investor will respond to a company of the same type or vertical as the startup company, or the like. If the startup company finds the investor to be a good fit, the startup company may select a selection mechanism (e.g., button, icon, toggle, etc.) on the investor abstract to send the startup company's materials to the investor. However, if the startup company does not find the investor to be a good fit, the startup company may discard the investor abstract.

If the system receives first party input accepting the request, the method 800 proceeds to operation 812 and the first party materials are transmitted to the second party device. For example, the system may enable access to the first party materials through the first party abstract. As one example, the system may move the first party abstract from the pending requests queue on a graphical interface of the second user device to a connected entities queue. The system may send a notification to the second party that the first party abstract is in the connected entities queue and/or that the first party has sent the company materials (e.g., by a feed notification and/or message). The second party may select the first party abstract, and the system may display an option for the second party to view the first party materials (e.g., as shown in FIG. 14 and discussed above). It is also contemplated that the first party materials may be sent to the second party by other mechanisms, for example, through a message in the system or by generation and transmission of an email or text to the second party's user device.

If the request was not accepted, and the system instead receives first party input to delete the second party abstract at operation 810, the method 800 proceeds to operation 814 and the second party abstract is discarded and the second party is notified. For example, the first party input may be received by the first party selecting a delete button on the second party abstract. Upon receiving the first party input, the system may remove the second party abstract from the pending requests queue displayed on the user interface and store the second party abstract in the deleted abstracts location. The system may send a notification (e.g., feed notification or message) to the second party that its request for first party materials was denied and/or its abstract was sent to the deleted abstracts location.

After operation 814, the method 800 optionally proceeds to operation 816 and the second party abstract may be stored as decision history, e.g., as discussed above with respect to operation 218 of FIG. 4. The decision history enables a startup company to keep track of investors the company passed on, e.g., in case they are needed for future rounds, or, as another example, allows a job applicant to keep track of companies the job applicant passed on, e.g., if the applicant's financial circumstances change. The decision history may also include second party abstracts that were removed from the pending requests queue due to expiration of the time limit.

### Feed Notifications

In some embodiments, the system may generate a “feed” of information and connections occurring between parties. For example, the system may generate a customized user feed display, for example, on the home window, that is personalized to the particular entity or user. The feed display may be a dynamic/live description and information of actions taken by the entity and/or transactions that take place between the entity and other entities or between other entities (for example, associated entities). The system may generate and transmit notifications to the feed display for actions involving the entity associated with the account. The system may display details of actions taken by the entity, e.g., the specific action taken, the entity user that performed the action, the time and date of the action, or the like. Without limitation, the system may display the following actions and transactions for an entity: activity on the account, when another entity views the entity's materials, when the entity views another entity's materials, when another entity requests to connect, when the entity requests a connection, when the entity accepts a connect request, when another entity accepts or declines a connection request, when another entity discards the entity's abstract (e.g., puts it in the deleted abstracts location), when the entity discards another entity's abstract, when another entity follows/tracks the entity, when the entity tracks another entity, when another entity stops tracking the entity, when the entity stops tracking another entity, when another entity (e.g., an associated entity) updates the other entity's abstract, or the like.

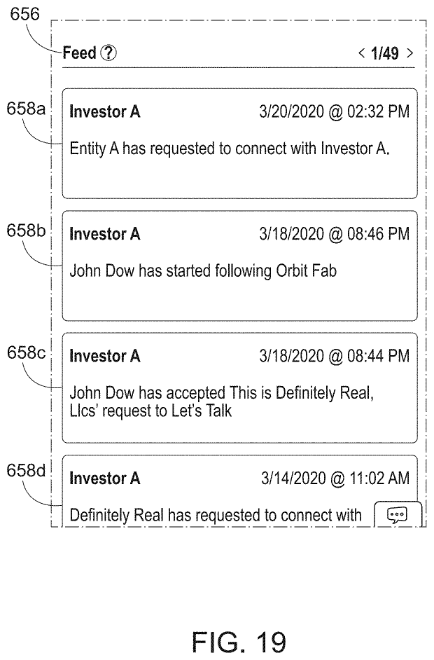

FIG. 19 shows an exemplary feed 656 that can be displayed on a graphical user interface of an entity device. As shown, the feed 656 includes several notifications 658a-c providing information on actions associated with a company account. The notifications 658a-c provide details on the company user that performed the transaction, the type of transaction, the other entity in the transaction, and include a date and time stamp. In the example shown, more recent transactions are depicted at the top of the feed 656. For example, the top notification 658a is the most recent event, in which an investor, Moore Collective, requested to connect with the company.

### Information Sharing with Similar Entity Types

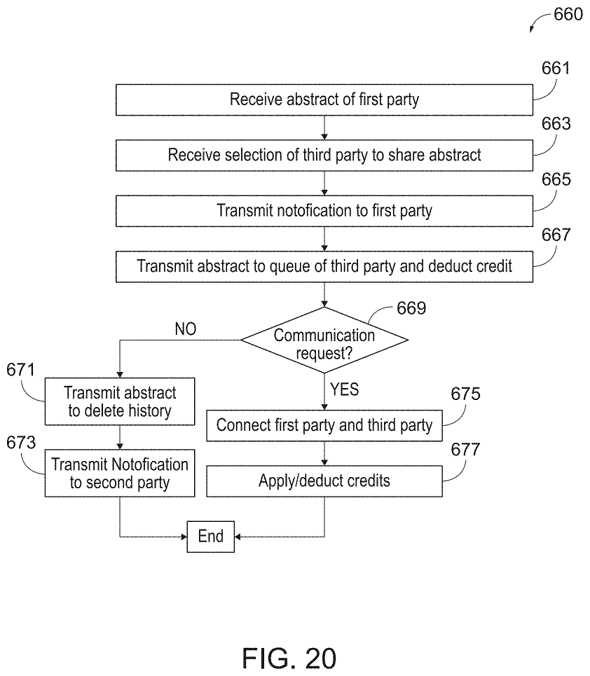

In some embodiments, similar entity types may share information. For example, investors may share information with other investors, companies may share information with other companies, or the like. As one example, investors may share company abstracts or company materials (e.g., deal flow). FIG. 20 is a flowchart illustrating information sharing between similar entity types. With reference to FIG. 20, a sharing method 660 may include operation 661 and a second party may receive information from a first party (e.g., an abstract from a startup may be transmitted to a first investor). In operation 663, the system 100 may receive a selection of a third party, e.g., a second investor, that is a similar type of entity or party as the second party. The selection may correspond to a selection to share the first party information.

In operation 665, a sharing notification may optionally be transmitted to the first party. The notification may be within the platform or separate therefrom, e.g., message, email, etc., and indicate that the second party has shared the abstract or other information with a third party.

In operation 667, the abstract of the first party may be transmitted to the queue of the third party. In some instances, because the second party and the third party are the same types of entities, e.g., both investors, the first party abstract as shared by the second party may be deposited automatically in the third party queue, rather than waiting for authorization or confirmation of communication. Similarly, the system 100 may not validate or determining matching characteristics between the first party and the third party when the first party information is transmitted directly between second entity types. Optionally, in operation 667, the system 100 may also deduct credits from the second party for the sharing transaction with the third party. By applying a cost to this type of transaction, the system 100 can help to reduce volume of communications, even between similar types of entities.

In operation 669, the system 100 determines whether the communicate request is accepted by the third party. For example, the third party may review the abstract or other information about the first party and determine that he or she wishes to connect. If in operation 669, the third party does not wish to connect, the method 660 proceeds to operation 671 and the abstract of the first party is transmitted to the discard or deletion history of the third party, e.g., the graveyard. Additionally, in operation 673 a notification may be transmitted to the second party indicating that the third party did not wish to establish a communication with the first party.

If in operation 669, the third party wants to connect with the first party, the third party may select a link or otherwise provide an input to the system 100 indicating that they wish to connect. Then, in operation 675, the method 660 may establish a communication pathway or introduce the first party and the third party. Optionally, in operation 677 the system 100 may apply and/or deduct credits for the transaction. For example, a credit may be awarded to the second party for establishing a successful connection and/or a credit may be deducted from the third party for using a faster route to connect with the first party. As should be understood the credit application and deduction may be varied as desired and used to incentivize or disincentivize certain behaviors across the system 100. To that end, the credit application and deductions may be dynamic and vary for similar transactions depending on the behaviors desired at the time.

As one example of the method 660, information may be shared between a first investor (Investor A) and a second investor (Investor B). For example, the first investor may have a company abstract in one of the investor's queues, for example, the company abstract may be located in a pending request queue (e.g., sent to the investor from the company), in an explore queue (e.g., recommended by the system as a matching company), in a connection queue (e.g., where the investor has connected with the company after reviewing the company materials), or the like. The system may include a selection mechanism (e.g., a share button) associated with the company abstract or the company materials that allows the first investor to share the company abstract or materials. The first investor may be prompted to select a second investor with whom the first investor wants to share the company abstract or materials.

The second investor may already be associated with the first investor. For example, the system may track one or more investors based on first investor input (e.g., by the first investor selecting the tracking button 523, as discussed above with respect to FIG. 14, or “friending” one or more investors). To receive first investor tracking input, the system may display a search engine or a list or queue of investor abstracts that the first investor can browse or search to locate investors.

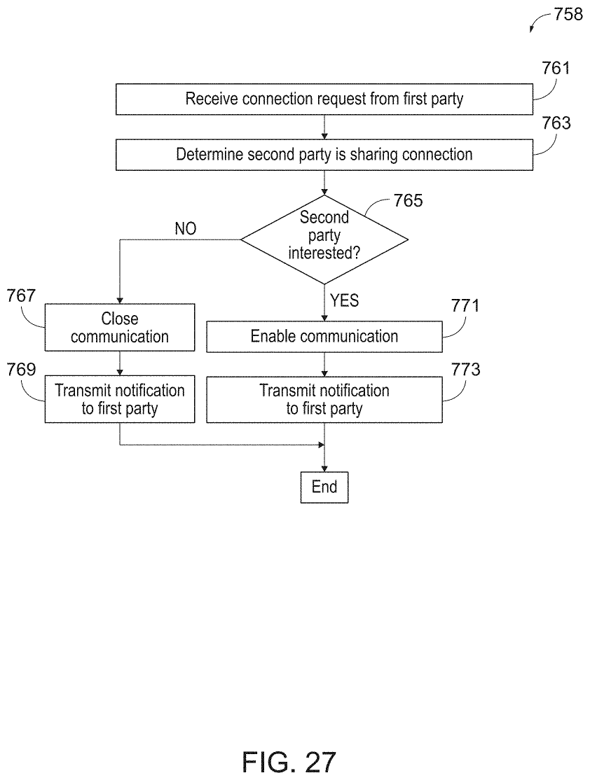

In some embodiments, the system 100 may be configured to enable connections between similar types of entities. FIG. 27 illustrates a flow chart for a method 758 to connect similar entity types. With reference to FIG. 27, the method 758 may include operation 761 and the system 100 may receive a connection request from a first party. For example, the first party may search for a second party on a search page and select a connect with option for the second party. In operation 763, the system 100 may determine whether the second party is open to a sharing connection. For example, the system 100 may allow certain parties to set preferences that limit the types of communications and connections on the system 100 and certain entities may wish to not connect with others. In some embodiments, the second party may be added to a “network” for the first party, e.g., the first party may be able to see certain activity and communications by the second party on the system.

Assuming that the second party has allowed sharing connections, the method 758 proceeds to operation 765 and the system 100 determines whether the second party is in fact interested in a connection with the first party. For example, the system 100 may present a request to a user device associated with the second party asking the second party to confirm that he or she wishes to connect with the first party. In instances where the second party does not want to connect, the method 758 may include operation 767 and the communication channels between the first party and the second party are closed (e.g., the first party may not be able to send notifications or communications to the second party directly) and optionally in operation 769 a notification may be transmitted to the first party alerting the party regarding the lack of interest.

If in operation 765, the second party provides an affirmative response to a connection request, the method 758 proceeds to operation 771 and communications are enabled between the first and second parties, e.g., the two parties can send messages directly to one another on the system. Optionally, in operation 773 the system may transmit a notification to the first party indicating that a communication pipeline may be opened between the two parties.

As a specific example of method 758, the system displays a search page to a first investor (Investor A) on a user interface of the investor's user device. In some instances, an entity may only be searchable if the investor account has sharing or searchable functions turned on (e.g., in the account preferences). For example, FIG. 21 shows a portion of an exemplary user interface 684 including a selection feature for turning the searchable function on or off, e.g., by selecting the enable button 691 or disable button 693, respectively. For example, if the searchable function is disabled, the system may prevent the entity from being visible or searchable by others on the platform, for example, preventing the entity from showing up in search results, from displaying its entity abstract in an explore queue, or the like. However, it is contemplated that the system may still enable the entity to send its entity abstract or materials to other entities while the searchable function is disabled.

Continuing with this example, the system may determine that a second investor (Investor B) has characteristics that match the search query. Before displaying the second investor in the search results, the system first determines whether the second investor has sharing turned on or off (e.g., in the second investor's account preferences). Alternatively, the system may exclude the second investor entirely from the search query function if sharing is turned off (e.g., will not take the step of determining whether the second investor matches the search query). If the sharing function is turned off, the system will not include the second investor in the search results.

If the sharing function is turned on, the system may display the second investor in the search results. If the system receives input from the first investor to send the second investor a request to join the first investor's network, the system may send the second investor a notification, e.g., in the second investor's feed, alerting the second investor that the first investor wants to connect. It is also contemplated that the system may transmit the first investor's abstract, which may populate in a pending invites feed or pending requests queue on a graphical user interface of the second investor's user device. The first investor may similarly have a pending invites feed (e.g., an outbound pending requests queue) for invite requests transmitted and awaiting a response. If the system receives input from the second investor accepting the connect request, the system may transmit a notification (e.g., a feed notification) to both investors that they are now connected. If the system receives input from the second investor declining the connect request, the system may transmit a notification (e.g., a feed notification) to the investors that the connection request has been declined and the connection is no longer available between the two investors. In this instance, the first investor may no longer be able to send a connection request to the second investor. It is contemplated that only certain authorized users (e.g., account administrators) may send and accept investor connection requests.

When the system receives input from a first entity to share an entity abstract or materials with a second entity (e.g., a similar or like entity type), the system may generate a prompt requesting the first entity verify the action. For example, sharing entity abstract/materials may cost the first entity a credit. The prompt may state, “Are you sure you want to share this Billboard with the Second Entity? −1 credit.” To proceed with sharing, the first entity may need to approve the prompt. When the system receives the share or approval input from the first entity, the system may send a notification to the first and second entities and the entity associated with the entity abstract being shared. For example, the system may send notifications to the first and second entities' feeds that a new entity abstract has been sent to or received from a contact in their network. The system may send a notification to the entity associated with the shared abstract that their entity abstract or materials has been shared with the second entity.

The system may transmit the shared entity abstract/materials to the second entity's pending requests queue, or a separate share requests queue. The system enables the second entity to review the shared entity abstract/materials as discussed above. If the system receives connection input from the second entity to connect with the shared entity (e.g., by a connection button), the system deducts a credit from the second entity account, and may allot additional credits to the first entity account (e.g., 2 credits, for a total gain of 1credit in sharing the shared entity and facilitating a connection). Alternatively, the system may receive deletion input from the second entity to discard the shared entity abstract (e.g., by the second entity selecting a delete button). The system may transmit a notification to the first entity and the shared entity of the actions taken by the second entity (e.g., by a feed notification).

The system may include options to link information with other operating systems, platforms, or networks. For example, the system may generate a URL link to an entity's abstract and/or materials. An entity can copy the link and paste it to the entity's website, social media accounts, marketing/advertising materials, or the like. The URL link may be auto-created by the system based on the type and name of the entity. For example, for a startup company, the link may be sendoutpost.com/startup/[startup name with no spaces]. The link may be customizable. For example, the system may receive customization input from an entity to customize the link (e.g., at the end) with the entity's own text. For example, FIG. 21 shows a portion of a user interface 684 including a customizable link 686. The customizable link 686 includes an established link segment 688 generated by the system and a customizable link segment 690, shown as a text box to input the customized text at the end of the customizable link 686.

The system may impose several restrictions and limitations on the customizable link 686. For example, the type of entity user that can customize the link may be restricted (e.g., only an administrator of the entity account), the number of times the entity may customize the link may be limited (e.g., only one time), and the text inserted into the customized link may also be restricted (e.g., limit of 200 characters, can only use letters, numbers and “_”, or the like, cannot use offensive/vulgar language, etc.). The system may determine when a restriction or limit is reached and disable any additional functionality with the link. For example, if a user tries to customize the link beyond the number of times allowed (e.g., a second time), the system may prevent customization. In this example, the system may generate a prompt for the entity user to submit a support ticket to have a system administrator assist with additional desired customizations.

As shown in FIG. 21, the entity user may select a Contact Support link 692 to get assistance with customizing the link. As another example, when an unauthorized user attempts to customize the link, the system may determine the user is unauthorized, prevent the unauthorized user from customizing the link, and transmit a notification to the user that the user is attempting an unauthorized action. The system may also prevent duplicate links from being created. For example, if the customized entity link matches a link that has been previously created (e.g., and stored by the system), the system may transmit a notification to the entity user that the link is already in use and the entity user needs to revise the link. The system may also prevent vulgar or offensive language from being used with a customized link. For example, if the system scans the customized text and determines the language is offensive (e.g., by comparing the customized text to a list of words or phrases stored by the system as offensive language), the system may transmit an error message to the user stating that vulgar or offensive language was found and the link cannot be saved until the language is revised.

### Conditional Automated Functions

In some embodiments, the system may execute automatic functions when a certain condition exists, such as a particular threshold being reached. For example, the system may execute a particular function once a threshold number of account users has performed the same action. The system may not execute a conditional function when the condition does not exist. For example, if a conditional function relies on at least two account users performing the same action, the system will not execute the conditional function where only one account user performs the action. Conditional functions may include a threshold number of users requesting entity materials, discarding an entity abstract (e.g., sending it to the deleted abstracts section), requesting a connection, or the like. In these examples, when the trigger occurs, the system will execute the associated action (e.g., transmit a request to the entity for the entity abstract, discard the entity abstract, transmit a connection request, etc.). Other conditions are contemplated, for example, a particular type of user (e.g., an investor with a relevant vertical, an account administrator, etc.) executing the action (e.g., the system may only execute an action when a particular user or threshold of particular users perform the associated action), type of plan (e.g., the system may execute functions based on the plan associated with the account), or the like.

When the system automatically executes a conditional function based on the condition existing, the system may execute the conditional function on behalf of the account user(s) that performed the action or on behalf of all account users. For example, if a threshold number of investor account users with a relevant vertical request company materials, the system may transmit a request to the company and, if the request is accepted, may transmit the company materials to the investor account users that requested it. As another example, if a threshold number of investor account users with a relevant vertical discard a company abstract, the system may discard the company abstract for the investor account (e.g., for all investor account users). As yet another example, if a threshold of investor account users with a relevant vertical request a connection with a company after viewing the company materials, the system may transmit a connection request to the company and, if the company accepts, may transmit the invite to the first investor account user who requested the connection or who requested the company abstract.

In some examples, when the system executes a conditional function when the associated condition exists, the system may transmit a notification to the account user(s) that performed the action or to all users on the account. In the example above, if the system discards the company abstract, the system may transmit a notification to all account users (e.g., a feed notification). Also in the above example, if the company denies the connection request, the system may transmit a notification to the investor account users that made the connection request or, alternatively, to all investor account users.

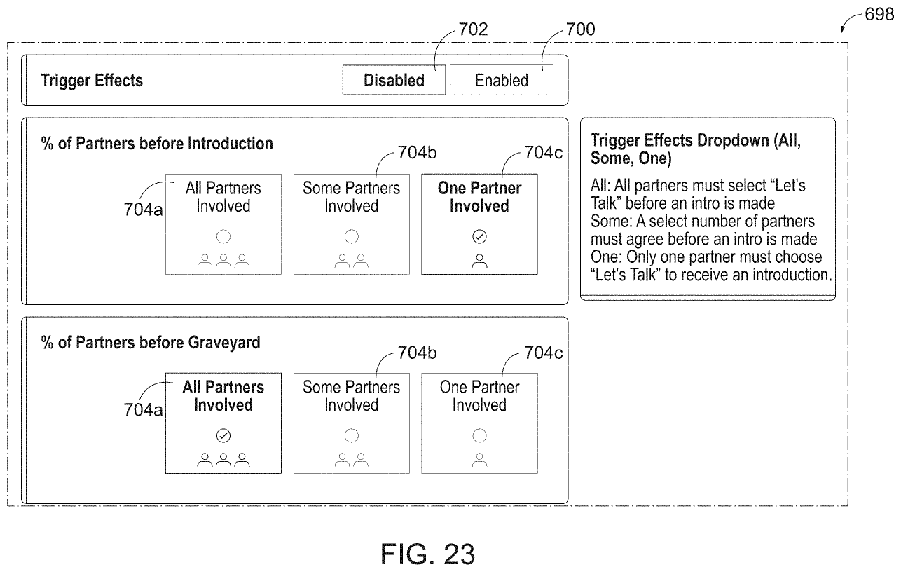

Conditional system functions may be customizable by an account user, for example, by an account administrator. For example, the particular condition that triggers the system to execute a function may be customized by a user. FIG. 23 shows an exemplary conditional functions window 698 (in this example, labeled “trigger effects”) on a graphical user interface of an entity device for customizing conditional functions. As shown, an entity user can enable or disable conditional functions by selecting an enable button 700 or a disable button 702; however, other selection mechanisms are contemplated, for example a toggle to turn the conditional functions on and off. If conditional functions are disabled, the system executes functions normally, e.g., when an account user performs an action, such as requesting a company abstract, the system executes the associated function, e.g., transmitting the request to the company.

In the example shown in FIG. 23, the conditional functions window 698 enables a user to customize conditions for introductions and deletion functions of the system. For example, the account user may set a threshold number of account users (in this example, partners) to be involved as a condition for the system to execute an introduction. In the depicted example, the conditional functions window 698 includes three condition selection options 704a,b,c for all partners to be involved, some partners to be involved, and one partner to be involved, respectively. In the current example, the account user has selected the condition selection option 704c for one partner to be involved before introduction. In other words, if one partner requests an introduction to a company, the system will execute functions to introduce the partner to the company.

As shown in FIG. 23, the account user has also selected the condition selection option 704a for all partners to be involved before a deletion function can be executed by the system. In other words, the system will not discard a company abstract until all partners have taken action to discard the company abstract. The system may have a number associated with “some” users involved (e.g., as shown in condition selection option 704b), e.g., two or three; however, it is also contemplated that an account user may be able to customize the number of users contemplated for “some” users involved. For example, the account user may set “some” to be at least two or at least three users. While three condition selection options are shown, more or less are contemplated with varying condition options.

It is further contemplated that the account user may customize who the action is executed for (e.g., who receives the introduction), who receives notifications when associated functions are executed (e.g., only the users that performed the action, all account users, etc.), or the like.

### Idle Mode

In some embodiments, the system may be configured to place accounts in an idle or hibernation mode. When an account is in idle mode, the system is configured with limited functionality for a particular account. For example, the system may retain the information for the account and keep the account active (e.g., allow users to log into the account and review certain information), but prevent certain user actions. For example, the system may restrict a user from sending or receiving entity abstracts, sending or receiving connection requests, viewing other user data or insights, or the like. The functionality in idle mode may vary based on the account type (e.g., Lite, Enhanced Premium), user preferences, payment plan, or the like. For example, a more expensive account may have more functionality in idle mode than a cheaper account. While an account is in idle mode, the system may still enable other users to track the account, for example, to receive notifications if the account is reactivated; however, the system may prevent other users from selecting the entity abstract to request materials or the like. Instead, if another user selects the idle entity abstract, the system may generate a prompt that states the account is in idle or hibernation mode (e.g., the startup company is not actively raising).

The system may place an account in idle mode when a user selects the option to make the account idle. For example, a startup company may use an account for multiple fundraising rounds but not need the account once rounds close. To retain the account information, the startup may place the account in idle. For example, a graphical user interface on a startup company user device may include a selection mechanism (e.g., a button) for closing a round. When the system receives input from the startup user to close the round, the system may prompt the startup user with a message box to keep the account active or place the account in idle with limited functionality and at a discounted rate. In this example, if the system receives input to keep the account active after the round is closed, the system may restrict the actions the startup company and others can take relative to the account (e.g., by disabling certain functionality). For example, the system may prevent a startup company to send and an investor to request the startup company abstract; however, the system may allow an investor to track or continue to track the startup company. Further, the startup company abstract may not be searchable. By limiting the functionality of a startup account when a round is closed and the startup is no longer fundraising, the system provides more meaningful connections between investors and startups actively seeking funding.

As another example, in a similar manner, the system may receive input from an investor to close a fund, prompting the system to display a message on a graphical user interface of the investor user's user device to keep the account active or place the account in idle with limited functionality and at a discounted rate. In this example, if the system receives input to keep the account active after the fund is closed, the system may restrict the actions the user(s) of the investor account can take relative to the account (e.g., by limiting functionality of the account). For example, the system may prevent an investor from requesting company materials; however, the system may allow the investor user to continue to track other entities. If the system receives input to place the account in idle mode, the system may further restrict the account users' actions, for example, the system may only allow the investor user(s) to view companies tracked by the investor account before closing the fund and prevent the investor user(s) from requesting to track new companies or requesting company abstracts. As another example, in idle mode, the system may allow investor account user(s) to continue to search for companies or to select company abstracts or links.

In this example, if the system receives input from the investor account user(s) to request company materials or track a company while the account is in idle mode, the system may generate an error message indicating the investor account user(s) cannot take such actions while in idle mode. The error message may include selection mechanisms (e.g., buttons) to cancel the request (which prompts the system to remove the error message) or open a new fund. When the system receives investor account user input to open a new fund, the system may first determine whether the account user is authorized to take such actions. For example, only an account administrator may be able to open a new fund. In this example, if the system determines the account user is authorized (e.g., an administrator), the system may display an investor abstract creation page to set up the new fund, or, in some instances, display an editable version of the existing investor abstract to modify according to the new fund. When the system receives investor account user input to save the new or modified investor abstract, the system displays the company abstract the investor account user(s) had initially tried to request or track. In this example, if the system determines the account user is not authorized, the system may display an error message indicating the account user cannot open a new fund and needs to contact an authorized user (e.g., the account administrator).

An account in hibernation or idle mode may be reactivated, for example based on account user or account administrator reactivation input (e.g., by selecting an option on a graphical user interface of an entity device to reactivate the account). For example, for a startup company, the graphical user interface may include a selection mechanism to open a new round, or for an investor, the graphical user interface may include a selection mechanism to open a new fund. In some instances, the system may prompt the entity user to create a new entity abstract; however, it is also contemplated that the entity user may update the existing entity abstract. When the system reactivates an entity account based on user input (e.g., a startup or investor opening a new round or fund, respectively), the system may display a prompt to the user inquiring whether the user wants to keep the existing account plan or change the plan. The prompt may include selection mechanisms (e.g., check boxes) to continue or change the plan, with options to input the preferred new plan. When the account is reactivated, the system generates a history or updates page (e.g., a “Since You've Been Gone” page), for example to provide the account user with updates on account activity (e.g., new followers) or updates on associated accounts (e.g., other user's the entity is tracking).

### Data Tracking and Analytics

In several embodiments, the system tracks/monitors data and is configured with various analytics capabilities to generate different trend data. For example, trend data may be based on location (e.g., list of locations receive entity abstracts/materials from, receive acceptances from, receive communications from, etc.), inbound deal flow (e.g., number of entity materials/abstracts received without request, etc.), outbound deal flow (e.g., number of entity materials/abstracts requested), total deal flow (e.g., weighted average of inbound deal flow and outbound deal flow), particular actions (e.g., number, amount, percent, average, etc. of communication requests/acceptances, entity abstracts received/accepted/discarded, entity material requests/acceptances, or the like), time frames (e.g., response times, times to review company abstracts/materials, etc.), characteristics of entities that connect, send/receive/accept entity abstracts/materials, or the like.

As one example, the system may generate data on average round size for startups that send their company materials directly to investors (e.g., inbound deal flow), average round size for startups that receive requests for their company materials from investors (e.g., outbound deal flow), weighted average round size for startups that send company materials without request and upon receiving requests for their company materials (e.g., total deal flow), average round size for startups that send the investor connection requests, average round size for startups that accept investor connection requests, or the like.

The system may be able to determine trending entities based on behaviors such as number of times the entity receives a materials/abstract/connection request or number of times the entity's requests are accepted. For example, a trending entity may have a greater percent (e.g., 70%, 80%, 90%, or higher) of incoming requests and accepted outbound requests than an entity that is not trending. By comparing entities in the same region, the system can determine regionally trending entities, and by comparing entities across a country, the system can determine nationally trending entities.

In some embodiments, the system may combine trend data. For example, the system may combine location and inbound/outbound deal flow trend data. As one example, the system may determine the number of company materials sent directly from startups to investors without request per location (e.g., inbound deal flow+location data). As another example, the system may determine the number of company materials requested by investors per location (e.g., outbound deal flow+location data).

In some embodiments, the system may generate trend data based on the entity type. For example, different information may be valuable for a startup company versus an investor versus a job applicant or the like. As one example, for a startup company, the system may generate data based on rounds or types. For example, the system may generate a list of rounds (e.g., Pre-Seed, Seed, Series A, etc.) or financing types (priced, debt, etc.) for startups using the system. The system may analyze inbound deal flow, outbound deal flow, total deal flow, and various activities in light of startup round or financing type information. For example, the system may determine the number of company materials/abstracts for a specific round/type that are received directly by investors that did not request them (e.g., inbound deal flow+round/type), the number of company materials/abstracts for a specific round/type requested by investors (e.g., outbound deal flow+round/type), total number of company materials/abstracts for a specific round/type that are exchanged, regardless of request (e.g., total deal flow+round/type), number of connection requests for a specific round/type (e.g., connection requests+round/type), number of connection requests accepted by startups for the specific round/type (e.g., connection requests confirmed+round/type).

Table 1 below shows exemplary data analytics output by the system for startup trend data based on rounds. While the data shown is represented as percentages, it is also contemplated that the data may be integers (e.g., number out of 100), ratios, totals, or the like. The system may display the table on a user interface of a startup user device or investor user device. The system may provide a toggle function for a user to toggle between different representations of the data (e.g., switch between percentages and integers). In the example table below, the default output by the system is percentages.

TABLE 1

| | Inbound | Outbound | Total | | |
|---|---|---|---|---|---|
| | Deal | Deal | Deal | Connections | Connections |
| Round | Flow | Flow | Flow | Requested | Confirmed |
| Pre-Seed | 26.8% | 31.5% | 28.1% | 20.0% | 26.7% |
| Series A | 73.2% | 68.5% | 71.9% | 80.0% | 100.0% |
| Total | 100.0% | 100.0% | 100.0% | 100.0% | 100.0% |

In several embodiments, the system includes capabilities for entities to review and track other entities' behavior, deal flow, and metrics. For example, the system may display entity data (e.g., behavior, deal flow, metrics) to entities so that they can review or track associated entities, as discussed above, a subset of entities (e.g., related based on type, market, vertical, etc.), or all entities. As one example, the system may provide transparency to a limited partner (LP) into how the LP's investments in various venture capital funds are performing. For example, an LP may be able to search funds or save funds in a queue on a home screen on a graphical user interface of the LP's user device, track the funds during fundraising, and compare the LP's investments with unbiased, quantitative data. By providing ease of review, the system may facilitate audit work.

The system may include a graphical user interface (e.g., a dashboard) that is uniform across multiple accounts and user devices (e.g., all accounts of a particular entity type, all accounts in the system, etc.), and that provides general data of system activity and performance, including analytics and key performance indicators. For example, a startup company dashboard may display various metrics for one or more startup companies that use the system, including for example, total number of company materials sent for a particular round or over a particular timeframe (e.g., last quarter, last month, etc.), total number of connections for a particular round or over a particular time frame, total number of connections for a particular region or vertical, estimated value of connections (e.g., a dollar amount calculated as the sum of the average check size of the funds/investors that have requested a connection), a percent to connect (e.g., a percent value calculated as a number of connection requests and confirmed/accepted divided by the (number of company materials requested plus the number of company materials sent)), the number of potential investors that fit/match (e.g., the number of investors on the platform who fit the criteria of the company, e.g., based on average check size, round, location, etc.), estimated value of company materials sent (e.g., a dollar value calculated as the sum of the average check size of the funds/investors that have requested or been sent the company materials), estimated time to close (e.g., a month value), estimated number of company materials needed to send to close the round (e.g., a numerical value), or the like. In this example, a startup company may use the collective data output by the system to predict the timeline and pathway to a successful round.

As another example, an investor user dashboard may display various metrics for one or more investors that use the system, including for example, total number of company materials requested by the investor, total number of company material sent directly to the investor by a company without request, average time to respond (e.g., average days or hours value for investor to request a connection or discard a company abstract from the time it is received by the investor), a percent to connect (e.g., a percent value calculated as number of connection requests and confirmed/accepted divided by the (e.g., a number of company materials requested plus the number of company materials sent directly to the investor), a percent of requests for company materials that lead to connections (e.g., a percent value calculated as number of company materials requested divided by the number of connection requests by the investor), a percent of received company materials that lead to connections (e.g., a percent value calculated as a number of company materials sent directly to the investor without request that are confirmed/accepted by the investor divided by the number of connections requested by the investor), or the like.

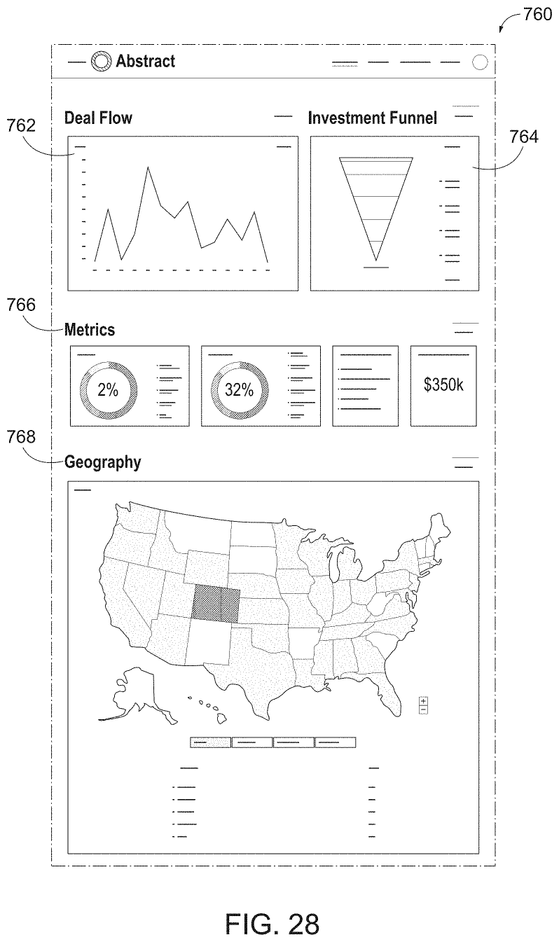

FIG. 28 shows an exemplary user dashboard 760 generated by the system that displays various metrics, including deal flow 762, an investment funnel 764, investor metrics 766, and geographical metrics 768. The deal flow 762 shows a graph of deal flow over time. The investment funnel 764 indicates the percentage of investors that have invested (bottom of funnel), connected (next tier up of funnel), reviewed company abstracts (next tier up of funnel), and total number of investors using the platform. The investor metrics 766 indicate the percentage of different types of investors (e.g., angel, venture capital, family office, accelerator, $1 B, etc.), the percentage of funds within a particular fund size (e.g., <$25 M, $25 M-$75 M, $75 M-$125 M, $125 M-$250 M, $250 M-$500 M, and $500 M+), fund vertical focus (e.g., the top verticals receiving funding), and the average check size for investments. The geographical metrics 768 show investment trends over different geographical locations, for example, across the different states.

For example, a user dashboard for an LP account user may look similar to the exemplary dashboard 760 shown in FIG. 28. For example, the user dashboard may include a dealflow graph chart (e.g., showing the amount of dealflow the LP is receiving sortable by time), an investment funnel (e.g., showing total investments, company material's reviewed, connections and dollar amount invested, sortable by number or percent), key metrics (e.g., stages of fund focus (e.g., seed, Series A, Series B, Growth), target fund size, vertical focus, and average check size, sortable by time), geography (e.g., where dealflow is coming from based on location sortable by total, inbound, outbound and last year). The user dashboard may include tabs for Due Diligence, Analysis and Investor Management, e.g., for easy review of the LP's investments.

For a startup user dashboard, it is also contemplated that the startup user dashboard may include information on the startup's current round, e.g., to assess how the startup is doing in comparison to the collective data metrics. For example, the startup user dashboard may provide information on the current stage, amount raised, type, and verticals for the startup. The dashboard may provide a comparison of a user's metrics with collective data (e.g., for entities having similar characteristics), for example, the startup user dashboard may display the amount raised by other startups at the same stage as the startup, the estimated total company materials other startups needed to send to raise the amount needed in the round, and the amount of company materials the other startup's needed to send to be able to close their round. By providing a means for the startup to compare its own metrics with collective data, the system can be used to help a startup predict the actions and time needed to close its round and set goals accordingly.

FIG. 26 shows a metrics or analytics output display 754 on the window 736 of a graphical user interface for a company device. In this example, the metrics display 754 includes five modals 756, including average amounts invested modal (e.g., “Total Value of Avg Check” breakdown), percent investor interaction modal (e.g., a percent of investors interacting with companies, e.g., “Investor Outreach” breakdown), a vertical ranking modal (e.g., highest ranking verticals being invested in, e.g., “Top Verticals”), a suggested action items modal (e.g., suggestions based on the performance of the company or company materials, e.g., “Smart Suggestions”), and an assistance modal (e.g., “Need Help?”).

As shown in FIG. 26, the average amounts invested modal may indicate the average amounts investors invest (e.g., value ranges) and the percent of investors providing those investments. The percent investor interaction modal may indicate the percent of investors that reached out to a company, requested company materials, requested a connection, tracked a company or were tracked by a company, were deleted, or the like. The vertical ranking modal may indicate the highest ranking verticals, for example the top three, four or five verticals. Vertical rankings may be determined by the number of investments, connections, information exchange, or the like, that occur in the vertical. The suggested action items modal may indicate trends associated with the company abstract (e.g., where entities stop reviewing the company materials, amount of time to review the company materials, etc.), and may provide suggestions for improving connections. In the example shown, the Smart Suggestion modal indicates that 73% of investors do not get past the company's Problem slide and suggests the company revise the company materials. The assistance modal may provide access to additional resources, for example, to have a professional review the company abstract or materials, obtain more credits, or ask questions. As one example, the metrics output through the metrics display 754 may be determined by the system in a similar manner as operations 302 and 304 of method 300 of FIG. 6.

### Conclusion

The technology described herein may be implemented as logical operations and/or modules in one or more systems. The logical operations may be implemented as a sequence of processor implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. For example, to the extent methods, systems, figures, and examples are described herein with reference to companies and investors, it is contemplated that these techniques and examples are equally applicable to other types of financial exchange platforms or types of entity or party connections (e.g., hirer-hiree, employer-independent contractor, fund-fund, etc.).

It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method of matching parties over a network comprising:
receiving a plurality of first party characteristics associated with a first party;
generating a first party abstract including at least some of the first party characteristics;
receiving one or more second party characteristics associated with a second party;
determining that one or more of the plurality of first party characteristics match within a threshold of one or more second party characteristics; and
transmitting a match notification to at least one of the first party or the second party.

2. The method of claim 1, wherein:
the plurality of first party characteristics comprise one or more of: a company location, a company type, a fundraising round size, or company revenue; and
the one or more second party characteristics comprise one or more of: an investing location, an investment company type, or an investment round type.

3. The method of claim 1, wherein transmitting a match notification to comprises transmitting the first party abstract to the second party.

4. The method of claim 3, wherein the first party abstract is placed in a queue of matches of the second party.

5. The method of claim 3, further comprising removing the first party abstract from the queue when a limit for reviewing the first party abstract is exceeded.

6. The method of claim 1, wherein the first party abstract comprises a link to enable communication between the second party and the first party.

7. The method of claim 1, wherein the first party is a company and the second party is an investor and at least one of the plurality of first party characteristics comprise financial information related to the company.

8. The method of claim 1, further comprising:
receiving from a second party user device associated with the second party a request to connect with the first party; and
transmitting a connection request to a first party user device associated with the first party.

9. The method of claim 8, wherein transmitting the connection request comprises transmitting a second party abstract associated with the second party to the first party user device.

10. The method of claim 8, further comprising:
receiving from the first party user device associated with the first party, an acceptance of the connection request;
generating an introduction message customized to the second party; and
transmitting the introduction message to the first party user device and the second party user device.

11. The method of claim 1, wherein direct communication between the first party and the second party is prevented until the match notification is transmitted.

12. A method for limiting interaction between parties over a network, comprising:
receiving, from a first party user device, a request to conduct a communication transaction with a second party;
determining, by a processor, an account associated with the first party has sufficient credits for the communication transaction based on a cost associated with the communication transaction;
enabling by the processor, the communication transaction between the first party device and a second party device associated with the second party; and
deducting by the processor the cost from the first party account.

13. The method of claim 12, wherein the account is reset to update credits at predetermined intervals.

14. The method of claim 12, wherein the cost is dynamic, depending on one or more of transaction parameters, first or second party characteristics, first or second party behaviors, or trend data.

15. The method of claim 14, wherein the trend data comprises data on trending parties and the cost increases when the second party is a trending party.

16. A method of promoting meaningful connections through a network, comprising:
receiving, from a first party user device, a request to transmit first party information to a second party;
transmitting, by a processor, the request to a second party user device;
receiving, from the second party user device, an acceptance of the request;
transmitting, to the second party user device, the first party information;
receiving, from the second party user device, a request to connect to the first party;
generating, by the processor, an introduction between the first party and the second party, wherein the introduction provides contact information for the first party and the second party; and
transmitting, by the processor, the introduction to the first party user device and the second party user device.

17. The method of claim 16, wherein:
the introduction is customized to include information for at least one of the first party or the second party; and
the contact information includes at least one of an email address or a phone number that is separate from the network.

18. The method of claim 16, wherein the first party information comprises an interactive abstract graphic and transmitting the first party information comprises transmitting the interactive abstract graph to the second party user device for display.

19. A system to connect two types of parties, comprising:
a processing device; and
computer readable medium containing programming instructions that, when executed, will cause the processing device to:
receive a plurality of first party characteristics corresponding to a first party;
generate based in part on the plurality of first party characteristics a first abstract summarizing at least some of the first party characteristics;
receive a plurality of second party characteristics corresponding to a second party; and
transmit the first abstract to a second party device based on a match of at least one of the plurality of first party characteristics and at least one of the plurality of second party characteristics.

20. The system of claim 19, wherein transmitting the first abstract comprises placing the first abstract in a queue of abstracts to be reviewed by the second party.

21. A method for enabling quick connections between a first entity and a second entity comprising:
receiving a selection of a connection link to a connection page, wherein the connection link is a uniform resource locator corresponding to the second entity;
loading a resource corresponding to the connection link;
receiving first entity characteristics corresponding to the first entity at the resource;
validating the first entity characteristics based on second entity characteristics corresponding to the second entity; and
enabling communication between the first entity and the second entity based on the validation.
